(19) United States
(12) Patent Application Publication
(10) Pub. No.: US 2007/0231621 A1
(43) Pub. Date: Oct. 4, 2007

(54) Fuel cartridge coupling valve

(76) Inventors: Manuel Arranz Del Rosal, Glendale, CA (US); Jeffrey L. Arias, Downey, CA (US); John P. Dubenko, Arcadia, CA (US); Dae Hwan Kim, (US); Kook Hwan Lee, (US); Robert E. Evans, Pasadena, CA (US); Robert G. Chave, Altadena, CA (US)

Correspondence Address: MINTZ, LEVIN, COHN, FERRIS, GLOVSKY AND POPEO, P.C, LA JOLLA CENTRE II, 9255 TOWNE CENTRE DRIVE, SUITE 600, SAN DIEGO, CA, 92121-3039, US

(21) Appl. No.: 11/655,782

(22) Filed: Jan. 19, 2007

Related U.S. Application Data
(60) Provisional application No. 60/761,034, filed on Jan. 19, 2006.
(60) Provisional application No. 60/847,240, filed on Sep. 25, 2006.
(60) Provisional application No. 60/855,346, filed on Oct. 30, 2006.

(51) Int. Cl. H01M 8/00

(52) U.S. Cl. 429/12

(57) ABSTRACT

Fuel cartridges for delivering fuel to a fuel consuming device, such as a fuel cell, are provided. Valves for use on cartridges or devices may include one or more internal seals that prevent fuel flow except when a valve is connected to a properly coupled corresponding valve and a seal between the two vales is established. Cartridge housings may include venting to maintain pressure equilibrium. A flexible or deformable fuel reservoir may be used with a pressurizing system that causes fuel to flow from a cartridge to a device independent of orientation.

### RELATED APPLICATIONS

This application claims the benefit of U.S. Provisional Application No. 60/761,034 entitled, “Fuel Cell Cartridge With Flexible Fuel Container,” filed Jan. 19, 2006, U.S. Provisional application No. 60/847,240 entitled “Connecting Device Valve For Micro Fuel Cell Power Units,” filed Sep. 25, 2006, and U.S. Provisional application No. 60/855,346 entitled, “Fuel Cartridge,” filed Oct. 30, 2006, all of which are incorporated herein by reference. This application is related to and incorporates by reference the following co-pending U.S. applications for patent: U.S. patent application Ser. No. Not Yet Assigned entitled “Fuel Cartridge,” filed Jan. 19, 2007 and assigned Attorney Docket No. 34788-502-UTIL; U.S. patent application Ser. No. Not Yet Assigned entitled “Fuel Cartridge,” filed on Jan. 19, 2007 and assigned Attorney Docket No. 34788-502-CON1; and U.S. patent application Ser. No. Not Yet Assigned entitled “Fuel Cartridge Coupling Valves,” filed Jan. 19, 2007 and assigned Attorney Docket No. 34788-502-CON2.

### TECHNICAL FIELD

The subject matter described herein relates to fuel cartridges for fuel consuming devices such as fuel cells.

### BACKGROUND

A number of applications require the use of liquid or gas-phase fuels that are provided in portable, self-contained fuel containers. These fuels may be toxic, flammable, or otherwise capable of causing damage if released from within their containers. A particular point of concern is the mode with which a fuel container or cartridge couples with a device to which the cartridge is to provide fuel. The device to cartridge coupling should be capable of quickly and reproducibly creating a sealed condition that directs fuel from the cartridge to the device without leakage to the outside. Coupling and decoupling modes of valves used for joining a device and a cartridge may be influenced by these considerations as well as by safety and convenience factors relating to preventing a cartridge valve from being activated if the cartridge is not properly connected to a compatible device.

One example of such an application are fuel cells incorporated into power sources for portable devices that may deliver longer runtimes than conventional battery systems because they utilize high-energy content fuels. Several fuel cell technologies include methanol, formic acid, sodium borohydride, fuel cells and hydrogen polymer electrolyte membrane fuel cells. However, to facilitate widespread adoption of fuel cells in portable power applications, improvements in fuel cell cartridges as well as fuel cell delivery systems are required.

### SUMMARY

In a first aspect, an apparatus includes an internal flow path having a first flow end and a second flow end, a fuel reservoir connected to the first flow end, and a deformable ring the deformable ring includes a substantially cylindrical outer surface, a first end and a second end, a circumferential ridge disposed between the first end and the second end encircling the outer surface, and an annular opening that leads from a first opening on the first end to a second opening on the second end. The annular opening includes an approximately cylindrical region near the first end and a conical region that tapers from the cylindrical region to the second end. The second opening is of smaller diameter than the first hole. The apparatus also includes a movable internal sealing member disposed within the internal flow path proximate to the second opening. The internal sealing member is biased against the second opening by a biasing force to form a liquid-tight internal seal that closes the second opening to block the internal flow path. The internal sealing member breaks the internal seal when a device valve of a separate apparatus contacts and forms an external seal with the conical region and then extends an actuating member through the annular opening to exert an opening force directed substantially opposite to the direction of the biasing force on the internal sealing member.

In further optional variations, the valve element may include a raised circular ridge on the second end that encircles the second hole. The valve element may also include a circumferential ridge disposed between the first end and the second end that encompasses the outer surface. The circumferential ridge may secure the valve element in place when the valve element is assembled in a compatible valve body. The deformable ring may include an absorbent material that absorbs fuel that might be released during a coupling or a decoupling of the conical region with the coupling member of the device valve. The apparatus may include a biasing support disposed within the internal flow path and an outwardly biased element providing the internal biasing force. The outwardly biased element may include a first spring end in contact with the biasing support and a second spring end in contact with the internal sealing member. The separate apparatus may include a fuel consuming device or a fuel cell.

The fuel reservoir may include a container with two opposing, substantially similarly sized, and substantially parallel sides that are connected by a deformable side wall or a flexible bladder. A substantially planar pressure plate may be included to apply a pressure against a side of the fuel reservoir. The pressure is substantially uniform with distance across the side of the fuel reservoir. The internal sealing member head may include a concave tip that provides a seating point for the actuating member. The actuating member may have a compatible convex tip. A fuel cartridge housing may be included to substantially enclose the fuel reservoir. A substantially planar pressure plate may be disposed proximately to a side of the fuel reservoir; and a pressure plate biasing element may be disposed between an internal surface of the fuel cartridge housing and the pressure plate. The pressure plate biasing element may provide a pressure plate biasing force that biases the pressure plate against the side of the fuel reservoir to provide a pressure that is substantially uniform with distance over the side of the fuel reservoir.

The apparatus may also include a ventilation plug disposed in ventilation port that passes through the housing and allows air pressure within the fuel cartridge housing to equalize with ambient pressure. The ventilation plug may include a first plug section, a second plug section, and a third plug section, all disposed along a common axis. The first plug section may include an outer face disposed opposite to the second plug section and the third plug section. The second plug section may have a smaller cross-sectional area than the first plug section. The third plug section may include at least one wing that extends wider than the second plug section. A blind hole aligned along the common axis and extending from the outer face and at least partially through the second plug section may intersect with a through hole passing through the second plug section substantially perpendicularly to the common axis, a porous material that is permeable to gases but substantially impermeable to liquids may fill the blind hole.

In a second interrelated aspect, a coupling of a fuel cartridge valve with a device valve of a device is initiated. The fuel cartridge valve includes an internal flow path having a first flow end and a second flow end, a fuel reservoir connected to the first flow end and a deformable ring the deformable ring includes a substantially cylindrical outer surface, a first end and a second end, a circumferential ridge disposed between the first end and the second end encircling the outer surface, and an annular opening that leads from a first opening on the first end to a second opening on the second end. The annular opening includes an approximately cylindrical region near the first end and a conical region that tapers from the cylindrical region to the second end. The second opening is of smaller diameter than the first hole. The apparatus also includes a movable internal sealing member disposed within the internal flow path proximate to the second opening. The internal sealing member is biased against the second opening by a biasing force to form a liquid-tight internal seal that closes the second opening to block the internal flow path. The device valve includes a coupling member configured to form a liquid-tight external seal with the conical region and to provide a liquid-tight external flow path connecting the device valve to the fuel reservoir via the internal flow path. The device valve also includes a movable actuating member. The actuating member extends through the annular opening to exert an opening force directed substantially opposite to the direction of the biasing force on the internal sealing member to break the break the internal seal. Fuel is caused to flow between the fuel cartridge housing and the device.

In a third interrelated aspect, a valve element includes a ring formed of a deformable material that includes a substantially cylindrical outer surface, a first end and a second end, and an annular opening that leads from a first opening on the first end to a second opening on the second end. The annular opening includes an approximately cylindrical region near the first end and a conical region that tapers from the cylindrical region to the second end. The second opening is of a smaller diameter than the first hole.

Various implementations of the presently disclosed subject matter may provide one or more of the following capabilities, or benefits. The fuel cartridge valves and device valves described may prevent leakage of excess fuel during engagement and disengagement of a fuel cell cartridge from a portable device. A substantially sealed state between a device valve and a fuel cartridge valve may be established prior to fuel or other materials flowing between the cartridge and the device. Various techniques, structures, and materials also reduce the likelihood of excess fuel droplets remaining upon the device valve upon disengagement of a fuel cartridge from a portable device, thereby lessening the incidence of damage to the portable device or other materials (such as for example a table, work materials, clothing, etc.) with which the fuel droplets might come in contact. Fuel cartridges may provide benefits including the ability to create a fuel path between a fuel reservoir in the cartridge and a fuel consuming device quickly, reproducibly, and reliably. Cartridges may be used in any orientation and may be used with either actively pumped or pressurized fuel consumption systems or with passive fuel consumption systems that rely on pressure created by the cartridge to cause fuel to flow. Fuel cartridges may be refillable as well.

These and other capabilities and features of various aspects of the presently disclosed subject matter will be more fully understood after a review of the detailed description and claims set forth below, as well as the accompanying drawings.

### BRIEF DESCRIPTION OF THE DRAWINGS

This disclosure may be better understood upon reading the detailed description and by reference to the attached drawings, in which:

FIG. 1 is an isometric diagram showing a portable device including a fuel cartridge;

FIG. 2 is an isometric diagram showing a first view of a fuel cell cartridge docking station;

FIG. 3 is an isometric diagram showing a second view of a fuel cell cartridge docking station;

FIG. 4 is an isometric diagram showing a portable device valve;

FIG. 5 is an isometric diagram showing a first exploded view of a fuel cartridge;

FIG. 6 is an isometric diagram showing a bottom housing for a fuel cartridge;

FIG. 7 is an isometric diagram showing a cross-sectional view of a bottom housing for a fuel cartridge;

FIG. 8 is an isometric diagram showing a detailed cross-sectional view of an anchorage for a cartridge valve on a bottom housing for a fuel cartridge;

FIG. 9 is an isometric diagram showing a detailed cross-sectional view of a fuel cartridge assembly;

FIG. 10 is an isometric diagram showing a detailed view of energy director ultrasonic welding features for a bottom housing of a fuel cartridge;

FIG. 11 is an isometric diagram showing a detailed view of tongue and groove ultrasonic welding features for a top and bottom housing for a fuel cartridge;

FIG. 12 is an isometric diagram showing a view of a ventilation plug;

FIG. 13 is an isometric diagram showing a cross-sectional view of a ventilation plug;

FIG. 14 is an isometric diagram showing a fuel cartridge assembly;

FIG. 15 is an isometric diagram showing a second exploded view of a fuel cartridge;

FIG. 16 is an isometric diagram showing a cross-section view of an assembled fuel cartridge valve;

FIG. 17 is a schematic diagram showing a cross-sectional view of a device valve and a fuel cartridge valve with the valves not in contact with each other;

FIG. 18 is a schematic diagram showing contact between a device valve and a fuel cartridge valve with a seal condition established;

FIG. 19 is a schematic diagram showing how an actuating pin of a device valve contacts a poppet in a cartridge valve;

FIG. 20 is a schematic diagram showing a cartridge valve being opened by the action of an actuating pin over a poppet in the cartridge valve;

FIG. 21 is a schematic diagram showing cross-section view of the assembly of various components of a device valve;

FIG. 22 is an isometric diagram showing a poppet valve;

FIG. 23 is a schematic diagram showing a frontal view of a poppet valve;

FIG. 24 is an isometric diagram showing a cross-sectional view of a valve slider;

FIG. 25 is an isometric diagram showing a first view of a holder lock

FIG. 26 is an isometric diagram showing a second view of a holder lock;

FIG. 27 is an isometric diagram showing a fuel cartridge body;

FIG. 28 is an isometric diagram showing a front view of a fuel cartridge body;

FIG. 29 is an isometric diagram showing a cross-sectional view of a fuel cartridge body;

FIG. 30 is an isometric diagram showing a cross-sectional view of a deformable ring of a fuel cartridge valve;

FIG. 31 is an isometric diagram showing a connecting device valve;

FIG. 32 is an isometric diagram showing a connecting device valve and a coupling fuel cartridge valve;

FIG. 33 is an isometric diagram showing an exploded component view of a device valve;

FIG. 34 is an isometric diagram showing an exploded cross-sectional component view of a device valve;

FIG. 35 is an isometric diagram showing a cross-sectional view of a valve stem cover;

FIG. 36 is an isometric diagram showing a cross-sectional view of a valve;

FIG. 37 is an isometric diagram showing a cross-sectional view of a valve stem gride;

FIG. 38 is an isometric diagram showing a valve stem;

FIG. 39 is an isometric diagram showing a cross-sectional view of a valve stem;

FIG. 40 is an isometric diagram showing a cross-sectional view of a valve stem sleeve;

FIG. 41 is an isometric diagram showing a cross-sectional view of a valve stem bushing;

FIG. 42 is an isometric diagram showing a cross-section view of a poppet housing;

FIG. 43 is an isometric diagram showing a cross-sectional view of a poppet valve;

FIG. 44 is an isometric diagram showing a cross-sectional view of a single valve fitting;

FIG. 45A is an isometric diagram showing a cross-sectional view a device valve;

FIG. 45B is a schematic diagram showing a second cross-sectional view of a device valve;

FIG. 46 is an isometric diagram showing a cross-sectional view of a device valve and a coupling fuel cartridge valve;

FIG. 47 is a schematic diagram showing a cross-sectional view of a fuel cartridge valve and a connecting device valve;

FIG. 48 is a schematic diagram showing a cross-sectional view of a fuel cartridge valve and a connecting device valve as the valves make contact;

FIG. 49 is a schematic diagram showing a cross-sectional view of a fuel cartridge valve and a connecting device valve as further contact is made between biasing elements in the valves;

FIG. 50 is a schematic diagram showing a cross-sectional view of a fuel cartridge valve and a connecting device valve showing the action of the biasing elements and the opening of the connecting device valve;

FIG. 51 is a schematic diagram showing a cross-sectional view of a fuel cartridge valve and a connecting device valve in which the fuel cartridge valve is opening;

FIG. 52 is a schematic diagram showing a cross-sectional view of a fuel cartridge valve and a connecting device valve in which the fuel cartridge valve is being opened by the action of the biasing element in the connecting device valve;

FIG. 53 is a schematic diagram showing a detailed cross sectional view of a fuel flow path in a connecting device valve coupled to a fuel cartridge valve;

FIG. 54 is a schematic diagram showing a detailed cross sectional view of a fuel flow path in a fuel cartridge valve coupled to a connecting device valve;

FIG. 55 is a schematic diagram showing a cross-sectional view of a coupler that includes a device valve and a cartridge valve;

FIG. 56 is a schematic diagram showing a cross-sectional view of an uncoupled fuel cartridge valve;

FIG. 57 is an isometric diagram showing a cross-sectional view of a valve body of a fuel cartridge valve;

FIG. 58 is an isometric diagram showing a cross-sectional view of an end cap of a fuel cartridge valve;

FIG. 59 is an isometric diagram showing a poppet of a fuel cartridge valve;

FIG. 60 is a schematic diagram showing a portable device valve;

FIG. 61 is an isometric diagram showing a main body or set front body of a device valve;

FIG. 62 is an isometric diagram showing a cross-sectional view of a housing body of a device valve;

FIG. 63 is a schematic diagram showing a cross-sectional view of a coupler that includes a device valve and a cartridge valve;

FIG. 64 is a schematic diagram showing a cross-sectional view of a fuel cartridge valve;

FIG. 65 is a schematic diagram showing a view of a device valve;

FIG. 66 is an isometric diagram showing a first view of a poppet for a fuel cartridge valve;

FIG. 67 is an isometric diagram showing a second view of a poppet for a fuel cartridge valve;

FIG. 68 is an isometric diagram showing a cross-sectional view of a valve body of a fuel cartridge valve;

FIG. 69 is an isometric diagram showing a cross-sectional view of a cartridge valve;

FIG. 70 is a schematic diagram showing an exploded component view of a cartridge valve;

FIG. 71 is a schematic diagram showing a cartridge valve near a device valve cannula;

FIG. 72 is a schematic diagram showing a cartridge valve coupled with a device valve cannula;

FIG. 73 is an isometric diagram showing a cross-sectional view of an assembly of a ventilation plug and the other associated components;

FIG. 74 is an isometric diagram showing a cross-sectional view of a fuel cartridge assembly;

FIG. 75 is an isometric diagram showing an exploded view of a sub-assembly of a fuel reservoir and a cartridge valve;

FIG. 76 is an isometric diagram showing a view of a completed sub-assembly of a fuel reservoir and a cartridge valve; and

FIG. 77 is an isometric diagram showing a cross-sectional view of a completed sub-assembly of a fuel reservoir and a cartridge valve.

### DETAILED DESCRIPTION

The subject matter disclosed herein relates to, among other topics, systems, structures, methods, materials, articles of manufacture, and techniques for coupling a fuel cartridge to a fuel consuming device, such as a fuel cell. Other devices, such as, for example, a cartridge filling device that provides fuel flow into the cartridge, may be connected to a fuel cartridge as disclosed herein. The coupling is accomplished in a manner that provides a positive connection between a fuel cartridge valve and a device valve. A flow path between the fuel cartridge and the fuel consuming device is established before fuel is allowed to flow. Once the fuel cartridge valve and the fuel consuming device valve are properly coupled to create a sealed condition, the fuel cartridge valve opens to allow fuel to flow between the cartridge and the device. In addition, small scale fuel leaks which may occur during mechanical coupling and uncoupling of the cartridge and device valve may also be prevented or mitigated using various approaches described herein.

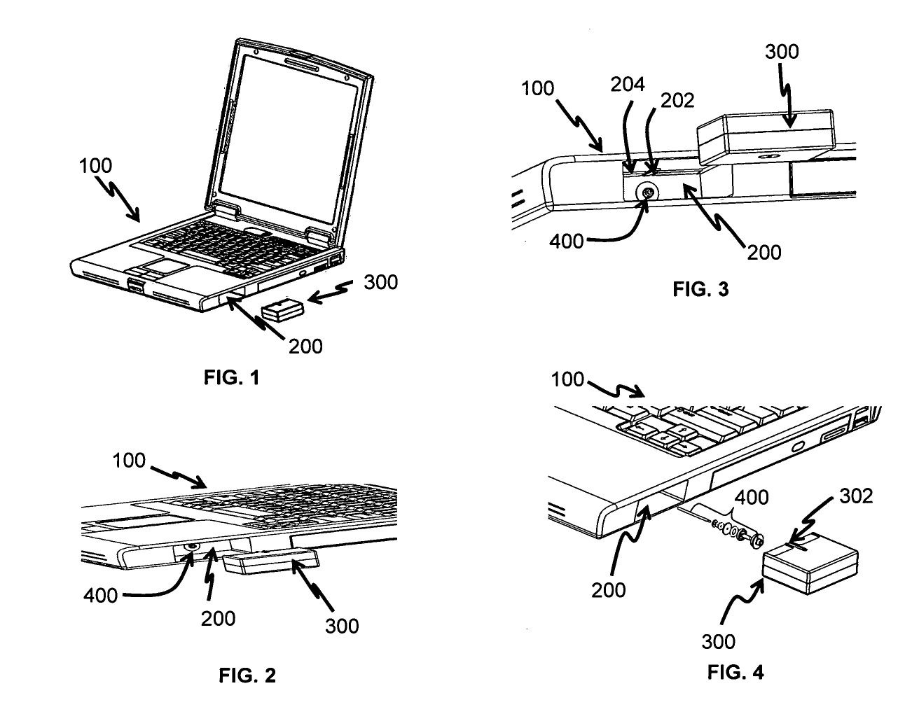

FIG. 1 shows a schematic view of an implementation of a fuel consuming device 100 which includes a docking station 200 for a fuel cartridge 300. In the example of FIG. 1, the fuel consuming device is a laptop computer. However, for the purposes of this disclosure, a fuel consuming device may refer to a portable computing device such as a laptop computer, a communications device such as a cell phone or a personal data assistant (PDA), an audio or video recording or playback device such as an MP3 player or a digital camera, other electrical or electronic device that may be operated using a portable supply of electrical power, and other devices that consume fuel, such as, for example, a portable grill or stove, a refillable cigarette lighter, etc.

The location of the docking station 200 for the fuel cartridge 300 as illustrated is not restrictive and it may be located in any location on the fuel consuming device 100 that may be compatible with the dimensions of the fuel cartridge 300.

FIG. 2 is a detailed view of the fuel consuming device 100 showing a fuel cartridge docking station 200 featuring a first implementation of a device valve 400. The device valve 400 may be aligned with an axis of the fuel cartridge 300. As shown in FIG. 2, the fuel cartridge 300 may be coupled to the device valve 400. In the example of FIG. 2, the device valve 400 may be a fuel supply valve that interfaces with a fuel cartridge 300 to provide fuel to a fuel feed sub-system that is coupled to or that forms part of a fuel cell that provides electrical power to the fuel consuming device 100. In this manner, the fuel cell may provide a longer lasting portable power source than may be provided by typically available batteries that are similarly sized relative to the fuel cartridge 300. The device valve 400 may be located in the docking station 200 of the fuel consuming device 100, optionally in a manner and location that protects the device valve 400 from mechanical and other types of damage that might occur if it projected outside of the standard form factor of the fuel consuming device within which it is installed.

FIGS. 3-4 show additional detailed views of the fuel consuming device 100, docking station 200, fuel cartridge 300, and portable device valve 400. The docking station may include one or more docking station keying and aligning features 202 and one or more ridges 204. Correspondingly, a fuel cartridge 300 designed to couple with such a docking station may include one or more cartridge keying and aligning features 302 and one or more grooves 304. In this example, a set of one or more keying and aligning features 302 in the fuel cartridge 300 engages and fits with one or more ridges 204, in the docking station 200, thereby creating a detachable engagement between the fuel cartridge 300 and the docking station 200. The number of grooves 304 and ridges 204, their particular engagement shape, and possible use in combination with other docking station alignment features 202 and cartridge keying and alignment features 302 may also prevent the use of counterfeit cartridges with the docking station 200 and fuel consuming device 100.

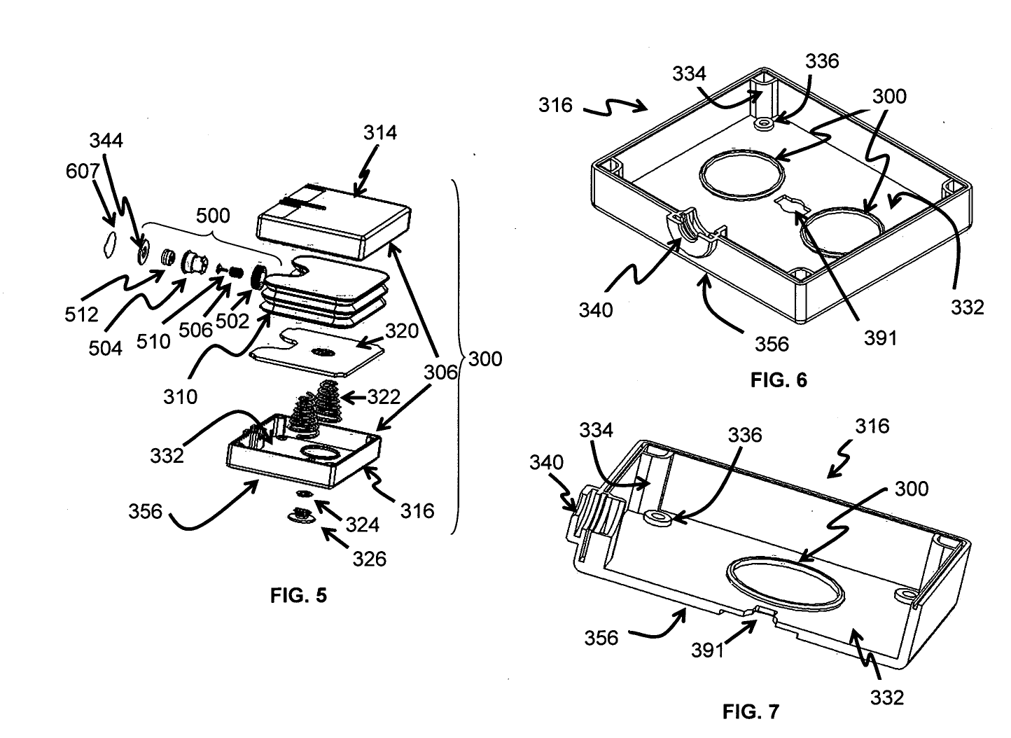

An exploded view of one implementation of a fuel cartridge 300 is shown in FIG. 5. As illustrated, this cartridge includes an assembly of an outer shell, outer casing, or outer housing 306 with a fuel reservoir that may be a flexible fuel reservoir or bladder 310 and a connecting valve 500 that dispenses fuel from the fuel cartridge to a fuel consuming device. In implementations in which the fuel cartridge 300 is used in connection with a laptop computer, the fuel reservoir 310 may optionally hold a volume of fuel within the range of approximately 40 to 65 mL. The fuel reservoir 310 may optionally be manufactured with a selected rubber material, such as for example PET, NEOPRENE®, HYTREL®, silicon, or a natural bladder material. The hardness of the fuel reservoir 310 may be selected to provide sufficient expandability and compressibility to accommodate the fuel volume to be contained in the fuel cartridge. The hardness may optionally be in the range of approximately 35 shore-A to 70 shore-A. The fuel reservoir 310 may also have one or more folds or bellows to provide better expansion and contraction performance. Other components of the fuel cartridge 300 may be manufactured with polycarbonate, a blend of polycarbonate with ABS, polycarbonate with a certain percentage of lass fiber (in one example, no more than 20%, in another example, less than approximately 8%), or LDPE Vow density polyethylene). The metallic materials, springs and retaining ring may optionally be manufactured of stainless steel (SS 302, SS 304, or SS 316).

The outer housing 306 of a fuel cartridge 300 may include a first or top housing 314 and a second or bottom housing 316. In addition to the fuel reservoir 310, the outer housing 306 may also include a pressure plate 320, one or more pressure plate biasing elements 322, which may be tapered or conical springs (two springs are shown in FIG. 5), a retaining ring 324, and a cap or ventilation plug 326. The pressure plate 320 and pressure plate biasing elements 322 may be incorporated into a fuel cartridge 300 to permit use of the cartridge with a passive fuel consuming device 100. A passive fuel consuming device does not include a mechanism for inducing fuel flow from a coupled fuel cartridge 300 to the fuel consuming component or components. In another example, an active fuel consuming device may have a pump or other means of inducing a pressure differential that causes flow to occur between the fuel reservoir 310 and the fuel consuming device 100. Fuel cartridges described herein may be designed for use with either passive or active fuel consuming devices 100. In the case of an active fuel consuming device, the pressure plate 320 and the pressure plate biasing elements 322 may be omitted. Alternatively, the pressure plate 320 and the pressure plate biasing elements may be retained but not activated when the fuel cartridge is manufactured and filled as described below.

FIG. 6 shows an isometric view of a bottom housing 312 of a fuel cartridge. In this implementation, one or more annular bosses 330 (two are shown in FIG. 6) may protrude a short distance (such as for example approximately 1 mm), from an inner surface 332 of the bottom housing 316. In one example of a fuel cartridge 300 for use in a laptop computer, the outside diameter for these annular bosses 330 may be approximately 22 mm. The annular bosses 330 may accommodate one or more pressure plate biasing elements 322, such as for example conical springs, in such a way that the inside diameter of the biggest coil spring slightly slips into the annular boss 330 with a relatively snug clearance (such as for example approximately 0.1 mm clearance within the outside diameter of the annular boss 330). By using this feature in the bottom housing 316, pressure plate biasing element or elements 322 may be properly positioned inside the fuel cartridge 300.

The bottom housing 316 may also include a guiding feature 334, which is represented in FIG. 6 by four 90° annular walls 334 which are located in the four interior corners of the bottom housing 316. In an implementation of a fuel cartridge for use in a laptop computer, the four annular walls 334 may have an approximate thickness of 1 mm, and leave hollow approximately one quarter of a circle enclosed between the annular wall 334 and the internal walls of the bottom housing 316. This configuration conserves wall thickness while avoiding potential plastic injection molding problems. These guiding features 334 help to guide the pressure plate 320 when it is compressed against the fuel reservoir 310, using the biasing force of the pressure plate biasing element or elements 322.

In FIG. 6, four stoppers 336 or supports are shown located near the guiding features 334. In this implementation, these stoppers 336 are hollow bosses that may protrude, for example, 1 mm in the same direction of the annular bosses 330, as shown in FIG. 6 and in detail in FIG. 7. These stoppers 336 support the pressure plate 320 when it is disposed nearest the inner surface 332 of the bottom housing 316. As discussed in greater detail below, the pressure plate may be locked against the inner surface 332 during assembly of the fuel cartridge. The stoppers 336 provide a uniform resting place and a maximum distance of retraction that the pressure plate 326 may experience.

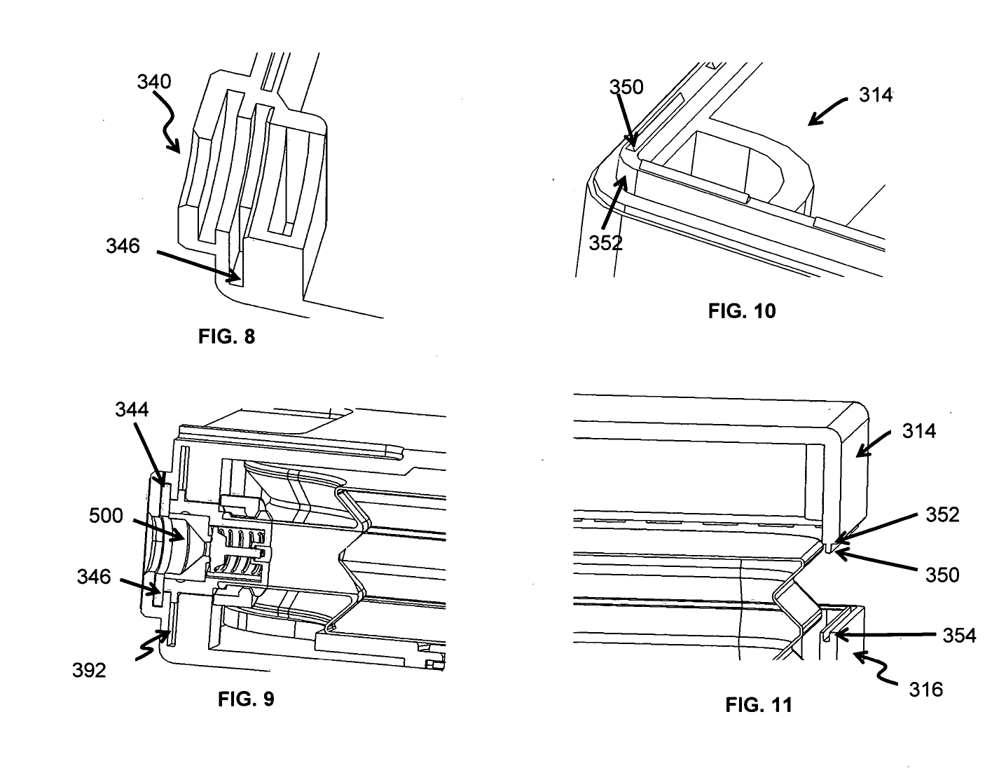

The bottom housing 316 and the top housing 314 of a fuel cartridge 300 may provide an anchorage 340 for a cartridge valve. In one implementation, the anchorage 340 may be formed of two halves, one on the top housing 314 and another on the bottom housing 316. These two halves fit with the outside shape of a cartridge valve, which may be enclosed and secured when the top housing 314 is joined to the bottom housing 316 to create a completed outer housing 306. The specific design may be provided in such way that these mechanical features can be easily accomplished by a plastic injection molding process. FIG. 8 shows a detailed cross-section of the half of an anchorage 340 formed by the bottom housing 316. In this implementation, a similar structure would also be present on the top housing 314. The anchorage 340 includes one or more channels or grooves 342 that correspond to features on a fuel cartridge valve to be fitted to the fuel cartridge 300.

FIG. 9 shows a magnified view of a cross-section of a fuel cartridge 300. In one implementation, the fuel cartridge 300 includes an absorbent material 344 to reduce possible leakage of fuel from within the fuel cartridge 300 to the exterior. FIG. 9 shows one example of a disposition of this absorbent component 344. The absorbent component 344 may include a disc made of a porous material, sponge, foam, or other comparable material. The absorbent may be made of a hydrophilic material. In one example of a fuel cartridge 300 for use in a laptop computer, the absorbent disc 344 may have an outside diameter of approximately a 14 mm and an inside hollow diameter of approximately 6.6 mm. The thickness may be approximately 1 mm, with a dimensional tolerance of approximately +/−0.1 mm. As shown in FIG. 9, the absorbent material 344 may be configured such that it does not block the fuel path between the cartridge valve 500 and a coupling device valve 400. This absorbent material disc 344 may absorb and retain any excess or remainder of fuel contained within the cartridge valve 500 when the cartridge valve 500 is disconnected from the device valve 400. In this figure it can also be appreciated that the location of the absorbent material 344 may be concentric with the cartridge valve 500.

Both the top housing 314 and the bottom housing 316 may include ultrasonic welding features. Primary factors that influence the joint design may be taken into account, such as for example the material to be used, the overall part size, load forces (if there are any), whether a visually attractive appearance is desired, etc. In some examples, the design of the joint may be accomplished by nimizing the initial contact area between top housing 314 and bottom housing 316 prior to ultrasonic welding and aligning the mating parts properly. The joint may be manufactured in a “tongue and groove” shape. Such an arrangement may prevent flash, both internally and externally, and may provide alignment. For the example of a laptop computer fuel cartridge, the energy director 350 design may include a peak of 90° that is as sharp as possible and a height of approximately 0.4 mm for amorphous resin, such as polycarbonate, used for the top housing 314 and bottom housing 316. One or both of the mating parts may be textured, to produce an improvement on the overall weld quality and strength by enhancing frictional characteristics and melt control. A sample texture may be in the range of approximately 0.076 to 0.152 mm. FIG. 10 shows a detailed view of the energy director 344 of the top housing 314. FIG. 11 shows an earlier stage of the assembly process prior to ultrasonically welding top housing 314 and bottom housing 316 together. FIG. 11 also shows a “tongue and groove” mating design of the joint, having the tongue 352 on the top housing 314 and the corresponding groove 354 on the bottom housing 312. Because the area to be ultrasonically welded may be substantially long, an “interrupted design” may be used. Such a design may reduce the overall welding area and subsequent energy or power level required to weld both parts together. FIG. 10 also shows a sample of this interrupted design. The length of an energy director peak 350 used in one variation for the top housing 314 may be approximately 4 mm.

Because of ambient temperature and/or pressure changes, gases may expand and create a pressure differential between the inside of the fuel cartridge 300 and the ambient conditions. This pressure differential could cause a deformation of the fuel cartridge housing 306 which could in turn cause the fuel cartridge 300 to no longer fit in the fuel cartridge docking station 200. To mitigate this effect, a fuel cartridge 300 may include a ventilation port. If there is any internal pressure developed inside the fuel cartridge 300 it will be dissipated by the ventilation port. A ventilation port may be located on any surface of a fuel cartridge 300. In the example of the fuel cartridge 300 shown in FIGS. 5-11, a ventilation plug 326 may serve as the ventilation port. In this implementation, the ventilation plug 326 is located at approximately the mechanical center of the outer surface 356 of the bottom housing 316. In the event of a breakage or other leak-causing damage to the fuel reservoir 310, a porous plastic plug within the ventilation plug 326 may prevent substantial leakage of fuel from the inside of the fuel cartridge 300 to the ambient. The ventilation plug 326 allows air to escape due to its gaseous permeability, but restricts liquid flow because it is effectively impermeable to liquids such as the fuel.

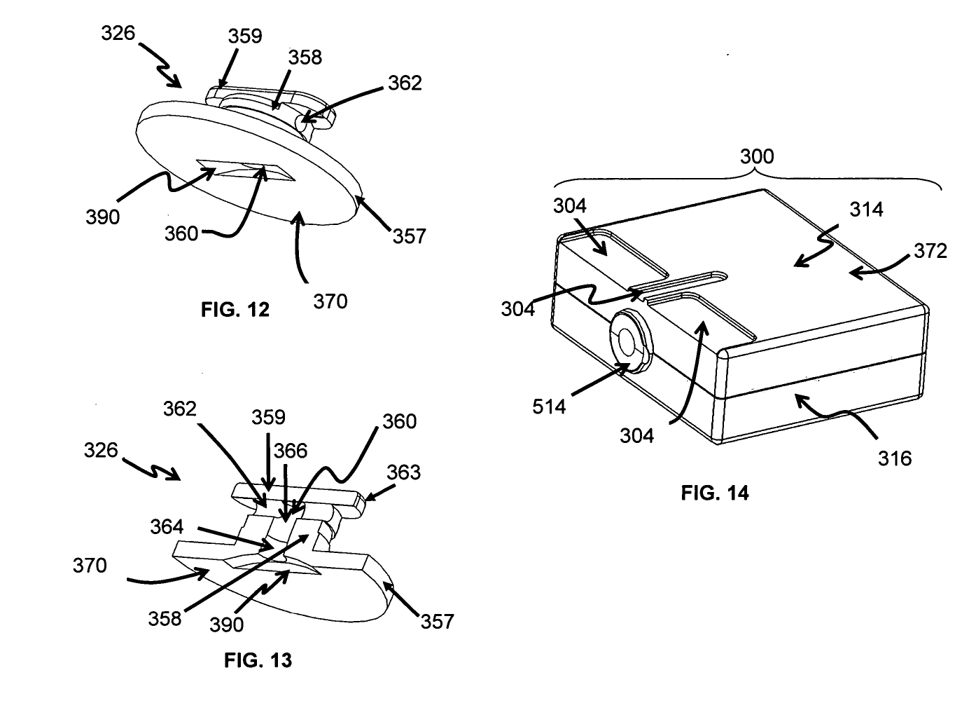

FIG. 12 shows an isometric view of the ventilation plug 326. The shape may be selected based on mechanical considerations in the fuel cartridge assembly. FIG. 13 depicts a cross-section showing features of a ventilation plug 326 in detail. In one implementation, a ventilation plug 326 includes a first plug section 357, a second plug section 358, a third plug section 359, vertical blind hole 360 and a horizontal through-hole 362. The first plug section 357, second plug section 358, and third plug section 359 may be disposed in sequence along a common axis. The blind hole passes through the first plug section 357 and at least part of the second plug section 358 where it intersects with the horizontal through-hole which runs through the width of the second plug section 358 and may be approximately perpendicular to the common axis. The third plug section 359 may include at least one wing 363 that projects outward beyond the outer circumference of the second plug section 358. The wing 363 may be used to anchor the ventilation plug securely inside the fuel cartridge housing 326 as described below.

The blind hole 360 may be filled with a plug of a porous material, which may take a cylindrical shape. The blind hole 360 may optionally include a first cylindrical section 364 and a second cylindrical section 366. The first cylindrical section 364 may have a draft angle of approximately 4° inward, having its biggest diameter by the outer face 370 of the first plug section 357, and its smallest diameter by its junction with the second cylindrical section 366. The second cylindrical section 366 may be a parallel cylinder or it may have a small draft angle (of for example approximately 0.5° to 1°) to facilitate removal (ejection) of the ventilation plug 326 from an injection mold during fabrication. The draft angle of the first cylindrical section 364 accommodates the insertion of a plug of porous cylindrical material having a similar diameter of the biggest diameter to the first cylindrical section 364. This method simplifies the process of inserting the plug of porous cylindrical material. Once the porous material encounters the second cylindrical section 366, it is compressed in a radial direction inwards, so the plug of cylindrical porous material may be held in place by friction and compression of its cylindrical body. In one example, the largest outer diameter for the first cylindrical section 364 may be approximately 1.92 mm, and the diameter of the junction between the first cylindrical section 364 and the second cylindrical section 366 may be approximately 1.75 mm. In this example, the diameter of the plug of porous cylindrical material may be slightly smaller than approximately 1.92 mm to make the insertion easier, but larger than approximately 1.75 mm, so the plug of porous cylindrical material may be held throughout the second cylindrical section 366 due to the interference of their respective diameters.

The blind hole 360 may be included in the design of the ventilation plug for safety. The ventilation plug provides a safety measure preventing direct pass-though access from the exterior of the fuel cartridge 300 to the fuel reservoir 310. If direct pass-through access is available, potential damage to the fuel reservoir 310 inside the cartridge 300 could be readily caused by just insertion of a sharp/pointed wire frame device or part with such a small diameter to penetrate the hole. Such an event could result in a substantial fuel leakage from the fuel reservoir 310 to the exterior of the cartridge 300.

The porous material plug may optionally be made of one or more of PTFE (polytetrafluoroethylene), nylon, polyamides, polyvinylidene, polypropylene, polyethylene, and the like. One suggested material for this application is POREX® Porous Plastics, which may be found from POREX® Technologies. POREX® Technologies offers Polyethylene (PE) in extra fine, fine, medium and coarse grades; and Polypropylene (PP) in medium and coarse grades. POREX® Porous Plastics are naturally hydrophobic, and back pressure flow rates are proportional to material thicknesses. Surface characteristics and pore size distribution may also affect permeability.

FIG. 14 shows an implementation of alignment features 304 on the top housing 314 of a fuel cartridge 300. These aligning features provide the proper alignment of the fuel cartridge 300 with a docking station 200 of a fuel consuming device 100 when the fuel cartridge 300 is inserted into the docking station 200. These aligning mechanical features may have complementary corresponding locks in the cartridge docking station 200. In one variation, the cartridge 300 may be equipped with three grooves 302, provided on the exterior surface 372 thereof to engage with and fit three corresponding ridges 204 provided in the interior surface of the docking station 200. The mechanical clearance between the grooved surface of the top housing 314 of the fuel cartridge 300 and the corresponding ridged surface of the docking station 200 in the fuel consuming device 100 may optionally be between approximately 0.1 mm and 0.15 mm so the cartridge 300 may be inserted on a slip fit mode, thereby assuring the proper alignment between a fuel cartridge valve 500 and the device valve 400.

The fuel cartridge may be identified with certain information included in an adhesive label attached on the outer surface of the housing. The number of labels is not limited to a certain number, but in one variation, there is a small label attached on the outer surface of the top housing 314, and a bigger label attached on the outer surface of the bottom housing 316. The text or information included in such a labels may include one or more of, the logo and name of the manufacturing company, a brief marketing statement of the manufacturing company, a UPC barcode, notes and warnings of proper usage, volume of the cartridge and fuel content used on this variation, i.e., 99% pure methanol, etc. The size of the label(s) may be determined according to marketing considerations, but always without mechanically compromising the outer dimensions of the fuel cartridge. The thickness of the adhesive film of the label(s) may be between approximately 0.15 mm and 2 mm. The selected base material for the label film may be, among other options, vinyl, polypropylene, or polyester. Some considerations for the material selection include, but are not limited to, weather resistance, indoor or outdoor application, flexibility to conform to varied surfaces, and durability. The application of special varnishes, coatings, lamination may be determined based upon marketing considerations.

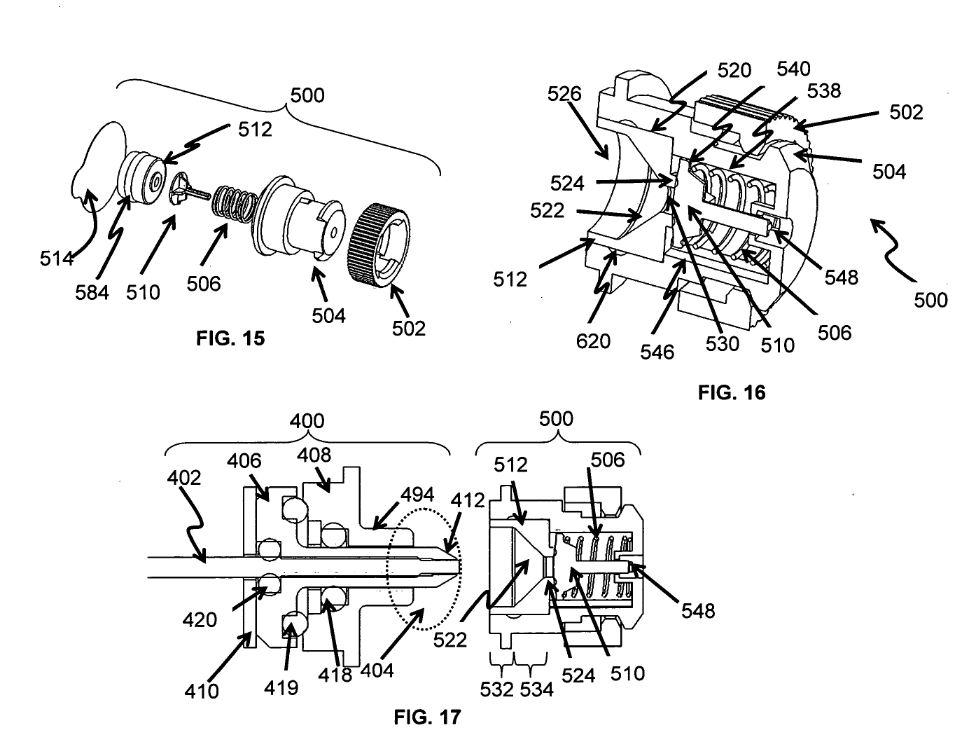

Various implementations of cartridge valves and corresponding device valves may be used in conjunction wvith fuel cartridges as disclosed herein. A first implementation of a device valve 400 is illustrated in an exploded component view in FIG. 4. A cartridge valve 500 that is compatible with this device valve 400 is illustrated in an exploded component view in FIG. 5. The device valve 400 may include an actuating member 402 that may be a pushrod, a coupling member 404 that includes a valve slider 406 and a valve nipple 408, and a washer 410. A cartridge valve 500 capable of coupling with the device valve 400 of FIG. 4 is shown in greater detail in FIG. 15 and FIG.16 which show an exploded component detail and an assembled detail, respectively. This cartridge valve 500 may include one or more of a holder lock 502, a cartridge valve body 504, an outwardly biased element 506 which may be a poppet spring, a movable internal sealing member 510 which may be a poppet pin, a deformable ring 512, and a vinyl safety cover 514. The fuel cartridge valve body 504 may encase the sliding poppet pin 506, which may be biased by a poppet spring 506 against the deformable ring 512.

The cartridge valve 500 exists in a default closed position such that flow from the fuel reservoir 310 to outside of the cartridge valve 500 is restricted by an internal seal that blocks an internal flow path unless and until an external seal has been formed with a properly coupled device valve 400. The external seal is created at an external sealing interface 522 and the internal seal is created at an internal sealing interface 524. In this implementation, the deformable ring 512 includes both the external sealing interface 522 and the internal sealing interface 524. The external sealing interface 524 includes a first annular opening 526 in the deformable ring 512. When the cartridge valve 500 is properly coupled to the device valve 400, a coupling member 404 of the device valve creates an external seal with the external sealing interface 522 such that flow through the first annular opening 526 is possible only between the internal flow path of the cartridge valve 500 and the interior of the device valve 400.

The internal sealing interface includes a second annular opening 530. When the cartridge valve 500 is not coupled to a device valve 400, the movable internal sealing member (poppet pin) 510 is biased against the internal sealing interface 524 of the deformable ring 512 to form an internal seal that closes the second annular opening 530 and thereby closes the internal flow path from the fuel reservoir 310 to the first annular opening 526.

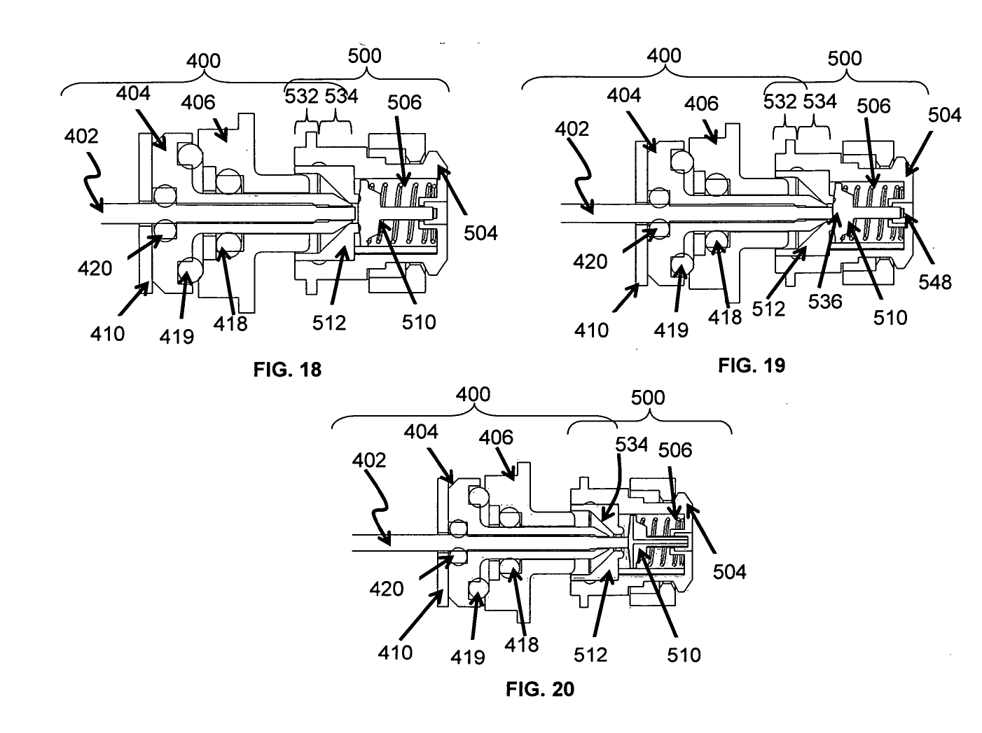

FIGS. 17-20 show cross-sectional views of a cartridge valve 500 and a corresponding device valve 400 in progressive stages of coupling between the two valves. Through such a sequence, the cartridge valve 500 and the device valve 400 couple to create a sealed fuel path and allow the fuel to flow between the fuel reservoir 310 in the fuel cartridge 300 and the fuel consuming device 100. Before the fuel consuming device 100 that includes the device valve 400 and the fuel cartridge 300 that includes the cartridge valve 500 are in contact, both valves remain closed. A fuel path has not been created yet. As the fuel cartridge 300 approaches the device valve 400, a coupling member 404 of the device valve 400 enters the first annular opening 526 of the deformable ring 512. The first annular opening 526 includes a parallel-walled region 532 leading to the external sealing interface 522 that is a tapered region 534 in which the cross-sectional area of the first annular opening 526 decreases with distance from the external surface of the deformable ring 512.

The deformable ring 512 may be circular, or alternatively of some other geometric shape such that it includes a substantially parallel-walled region 532 in which the cross-sectional area of first annular opening 526 does not substantially change with distance along the axis of the deformable ring 512. For a circular deformable ring 512, the annular space parallel-walled region 532 may be substantially cylindrical. The tapered region 534, is conical with the cross-sectional area decreasing with distance from the parallel-walled region 532. Other cross-sectional geometries for the first annular opening 526 and the parallel-walled region 532 and tapered region 534 may be utilized depending on the configuration of the cartridge valve 50 and the device valve 400.

A mutual seal between the two valves is not created as the coupling member 404 enters the parallel-walled region 532 of the deformable ring 512. The parallel-walled region 532 serves to guide the coupling member 404 to the external sealing interface 522 that includes the tapered region 534 where the external seal is created. For a circular deformable ring 512 and coupling member, the mner diameter of the straight region 532 may be large enough to provide sufficient radial clearance between the coupling member 404 and the parallel-walled region 640 of the deformable ring 512 to allow the valve nipple 408 to enter without restriction. The radial clearance may optionally be in the range of approximately 0.1 mm to 0.2 mm. For a non-circular deformable ring 512, the cross-sectional geometry of the parallel-walled region 532 may be similar to but slightly larger than the cross-sectional geometry of the valve nipple 408.

As the fuel cartridge 300 progressively enters the docking station 200, the device valve 400 and the cartridge valve 500 make contact. A tapered head 412 of the coupling member 404 contacts the tapered region 534 of the deformable ring 512, as shown in FIG. 6B. For a circular deformable ring 512 and conical tapered region 534, the tapered head 412 may also be conical. Other geometries are possible provided that the tapered head 412 and tapered region 534 may be pressed together to form a continuous line of contact around the entire circumference of the tapered head 412.

Contact between the tapered head 412 and the tapered region 534 around this line of contact creates a seal between the two connecting valves. As the coupling member 404 continues pushing against the tapered region 534, the deformable ring 512 deforms slightly due to pressure applied by the coupling member 404 against it. In addition, the valve slider 406 recesses slightly and that movement may be maintained by a device valve biasing element 414 that may be an expansion coil spring. The device valve biasing element 414 may be contained by the washer 410, as shown in FIG. 21. The tapered head 412 may also be made of a material that deforms at least slightly as the valve slider 406 presses the tapered head 412 against the tapered region 534. The washer 410 may be metallic. FIG. 21 also illustrates fixed device valve anchoring supports 416 that are substantially fixed and rigid solids which are parts, such as for example a laptop computer internal frame or external case, of the fuel consuming device 100. One or more device valve O-rings 418, 419, 420 contain the fuel and prevent it from traveling and filtering through the clearance among the different assembled components of the fuel consuming device 100.

FIG. 21 illustrates an implementation in which a small motorized, spring loaded push washer 422, or any other similar component or device pushes the actuating member 402 after the tapered head 412 and the tapered region 534 are pressed together to form an external seal encompassing the fuel flow path. Once this condition is achieved, the portable device valve 400 opens. As FIG. 21 shows, the spring loaded actuating pin 402 for the device valve 400 moves forward toward the internal sealing member (poppet pin) 510 (in one implementation for an approximate stroke of 0.5 mm to 2 mm) to compress a device valve biasing member 412 which may be a spring. The actuating member 402 moves forward until it reaches an outer convex face 536 of the poppet pin 510, as shown in FIG. 19. As shown in FIG. 20, further movement of the actuating member 402 toward the internal sealing member 510 (poppet pin) overcomes the force of the outwardly biasing member 506 (poppet spring) and pushes the internal sealing member 510 away from the internal sealing interface 524 and consequently opening the internal flow path of the cartridge valve 500. This action creates the fuel path through which fuel flows between the fuel cartridge 300 and the fuel consuming device 100.

A fuel cartridge valve body 504 encloses the internal sealing member 510, which in turn may be guided by an internal boss 538 in the fuel cartridge valve body 504 as shown in FIG. 16. In this implementation, a poppet pin 510 is biased by a poppet spring 506, which couples to the poppet pin 510 at a flat surface 540 on the side of the poppet pin head opposite the convex surface 536, as shown in FIG. 16. When the poppet pin 510 is pushed by the actuating member 402 of the portable device, it recesses, thereby compressing the poppet spring (outwardly biased element) 510 and allowing fuel to flow through the cartridge valve 500.

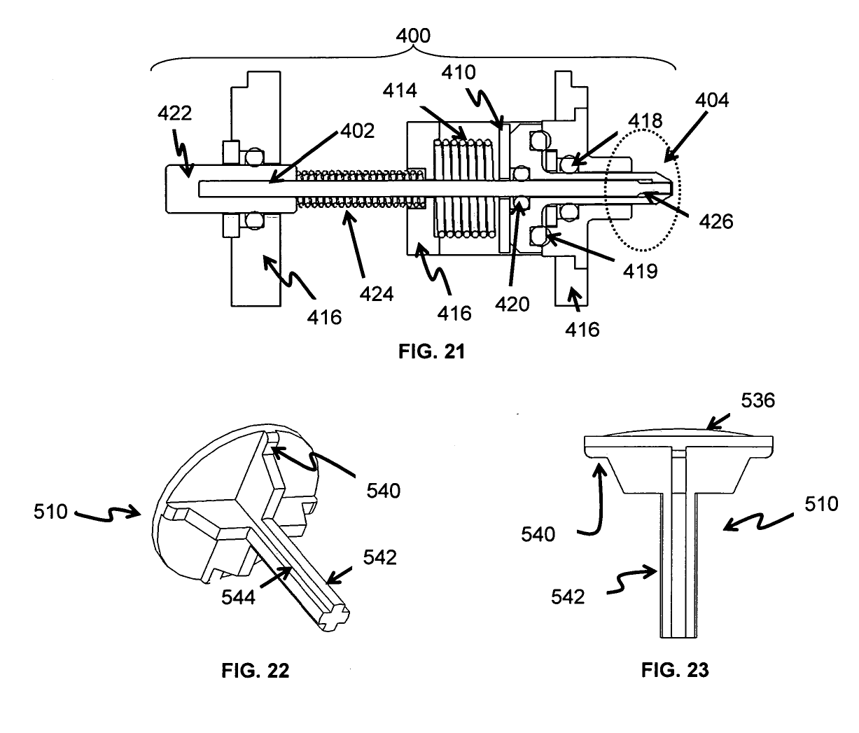

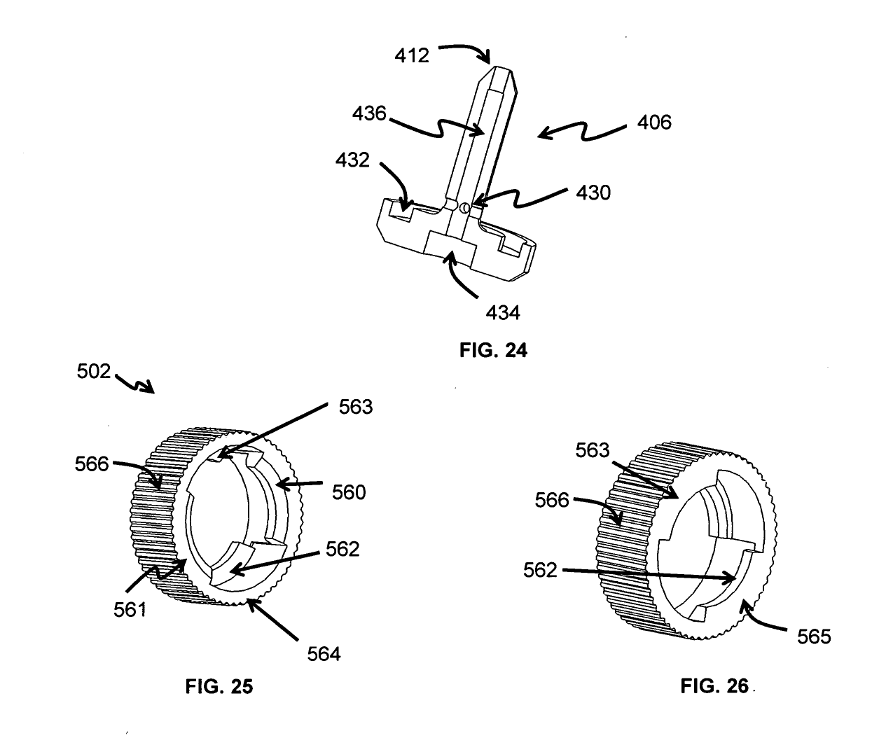

In one implementation, the design of the poppet stem 542 may have a cross-shaped cross-section, as shown in FIG. 22 and FIG. 23. With this cross-shaped design, four stem grooves 544 in the poppet stem 542 form flow channels through a fuel port 548 that the poppet stem 542 passes through in the base of the valve body 504. These flow paths allow the chamber enclosed by the poppet pin 510 and the boss 538 of the valve body 504 to fill with fuel from the fuel reservoir 310. Other cross-sectional configurations for the poppet stem 542 are possible as well. For example, fewer or greater than 4 grooves may be provided for fuel flow along the axis of the poppet stem 542 through the fuel port 548. In one implementation, the radial clearance between the poppet pin 510 and the internal walls of the valve body 504 may be in the range of approximately 0.1 mm to 0.2 mm. Fuel flow around the head of the poppet pin 510 and to the second annular opening 530 may be eased by having a grooved channel 546 in the valve body orifice 520, as shown in FIG. 16. The grooved channel provides a flow path around the head of the internal sealing member 510 (poppet pin). Fuel flows through the valve body 504 and enters the deformable ring 512. As a seal has been created between the portable device coupling member 404 and the deformable ring 512, the fuel continues through an annular path 426 between the actuating member 402 and the valve slider 406.

FIG. 22 illustrates one implementation of a valve slider 406 in cross section. Fuel may be prevented from continuing its path to the internal mechanical components of the fuel consuming device by O-rings 418, 419, 420 as noted above. A circular groove 432 houses a larger O-ring 419 to prevent any leakage of fuel from the portable device valve 400 to the inside of the fuel consuming device 100. Fuel leakage into certain fuel consuming devices 100, particularly electronics, may cause unknown damage to internal mechanical and electrical components. A cylindrical cut 434 houses a smaller O-ring 420 to reduce the likelihood of leakage of fuel stranded in the annular area created between the actuating member 402 outside diameter and the inside diameter of a valve slider channel 436 to the internal components of the fuel consuming device and/or the device valve 400 after disconnect of the device valve 400 and the cartridge valve 500. From the through-holes 430, the flow path conducts fuel to the fuel consuming device 100. Fuel flows through the annular space between the valve slider channel 436 and the actuating member 402 from the conical head 412 of the valve slider 406 to the diametric through-holes 430. Once the fuel reaches the through-holes 430, it may be re-routed perpendicularly through the through-holes 430 (separated 90° from each other), and to the fuel cell or other fuel consuming device. In other implementations, one or more through-holes may be provided for the fuel path. The annular cross-sectional area of the slider channel 436 may be such that the radial difference between the slider channel 436 of and the actuating member 402 is optionally in the range of approximately 0.1 mm to 0.15 mm.

A valve slider 406 may be manufactured from, for example, polycarbonate, LDPE Now density polyethylene), stainless steel, or other comparable materials. The dimensions of the valve slider 406 may optionally be as follows: height between approximately 15 mm and 16 mm, outside diameter between approximately 12.5 mm and 13 mm, and outside diameter for the long vertical neck between approximately 3.10 mm and 3.20 mm.

To assemble and hold the fuel reservoir 310, the fuel cartridge valve 500 may include a holder lock 502 as shown in detail in FIG. 25 and FIG. 26. The holder lock connects the cartridge valve body 504 to the fuel reservoir 310. The holder lock 502 shown in FIGS. 25-26 includes two pairs of locking arms (560, 561, 562, and 563) separated 180° from each other on each side, 564 and 565. Both pairs of arm locks may be separated 90° from each other. Such an arrangement facilitates plastic injection molding for manufacturing. Alternatively, other orientations of the arm locks may be used. The holder lock 502 may be constructed of polycarbonate, LDPE Cow density polyethylene), or other comparable materials. The dimensions of the holder lock 502 may optionally be as follows: interior diameter between approximately 4 mm and 6 mm, exterior diameter between approximately 6 mm and 6.5 mm, and height approximately 4 mm. A holder lock 502 may include an exterior grip 566 to ease handling and rotating of the part when it is assembled and engaged with the valve body 504. The holder lock features are designed to provide an interactive lock with corresponding features on the valve body 504 as discussed below.

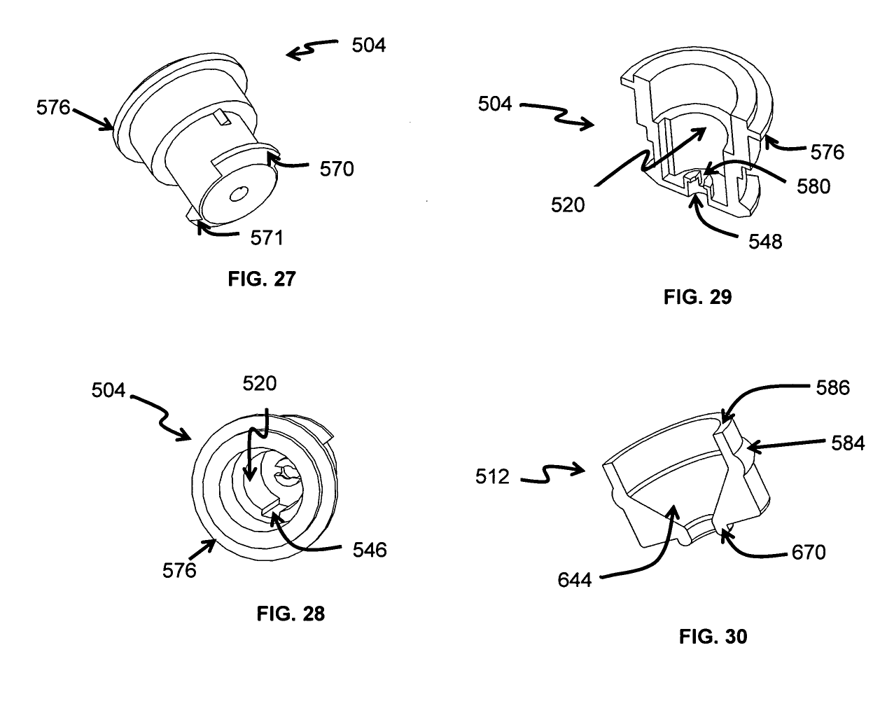

FIGS. 27-29 show mechanical features of a fuel cartridge valve body 504. FIG. 27 shows two locking arms, 570 and 571, separated 1800 from each other. These locking arms, along with the locking arms of the holder lock 502, create a retention system between the valve body 504 and the holder lock 502. In this example, dimensions for a fuel cartridge valve body 504 for use in a fuel cartridge for use with a laptop computer may optionally be as follows: external flange 576 diameter between approximately 12.5 mm and 13 mm, internal diameter for the valve body orifice 520 that houses the poppet 510 between approximately 5.4 mm and 5.6 mm, and total height of approximately 12 mm. FIG. 28 shows the channel 546 on the leading edge of the valve body orifice 520. The channel 546 may be used to conduct the fuel through the chamber 520 from the fuel reservoir 510 and the device valve 400. FIG. 29 shows a cut view of the valve body 504, also showing the channel 546 and the fuel port 548 which also may function as a guiding and aligning feature. The guiding and aligning feature 548 guides the stem 542 of the poppet pin 510 or internal sealing mechanism, which may be pushed by the actuating member 402 from the portable device valve 400, compressing the poppet spring 506 or outwardly biasing element. An indent 580 is also shown in FIG. 10C. An indent 580 may be included in the fuel port 548 to ease the flow of fuel through the valve body 504 when the poppet pin 510 is biased away from the internal sealing interface 524 and the cartridge valve 500 is open.

As noted above, a cartridge valve 500 may include a deformable ring 512. A cut section of an implementation of a deformable ring 512 is shown in FIG. 30. The overall dimensions of the deformable ring 512 may optionally be as follows for use in a fuel cartridge for a laptop computer: between approximately 5 mm and 5.5 mm tall, approximately 7.5 mm outside diameter, and an approximately 45° conical entrance with 2 to 2.5 mm high. A circumferential ridge 584, which may be hemispherical in cross section may optionally be situated on the outside of the deformable ring 512 to assist in seating the deformable ring in the cartridge valve body 504. The circumferential ridge 584 may optionally be located between approximately 0.5 mm and 1 mm away from the first side of the deformable ring 512 along the radial axis of the deformable ring 512. The deformable ring 512 may be inserted by press fit mode into the valve body orifice 520 of the valve body 504. The circumferential ridge 584 provides friction against the interior of the valve body orifice 520 to maintain the deformable ring 512 in its proper position in the valve assembly 500. In addition, a retaining ring 344 (discussed above and shown in FIG. 5) may be added on top of an exterior-facing surface 586 of the deformable ring 512 to enclose the deformable ring 512 and reduce its susceptibility to being dislodged from the valve assembly 500. The retaining ring 344 may be made of an absorbent porous material such that the retaining ring 344 provides a temporary sink for fuel droplets that might escape when the cartridge valve 500 is coupled and decoupled from the device valve 200. The deformable ring 512 may also be made of a porous absorbent material to absorb small fuel droplet spills.

When the cartridge valve 500 and the device valve 400 create an external seal, the valve slider tapered head 412 contacts the surface of the tapered region 522. This contact may optionally occur at a distance of approximately 4 mm to 4.75 mm from the upper surface 586. The deformable ring 512 also creates a seal with the poppet pin 510 when the cartridge valve 500 is closed. In this situation, the annular section 524 of the internal sealing interface mates with the upper convex surface 536 of the poppet 510, blocking flow from the fuel reservoir 310 when the cartridge valve 500 is not coupled to a device valve 400.

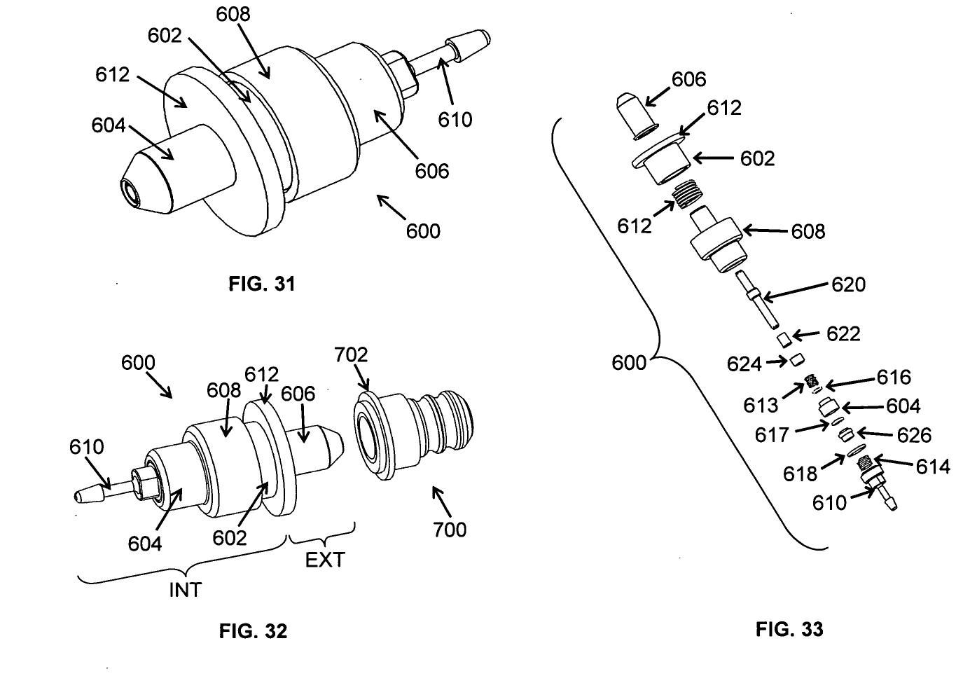

An alternative implementation of a device valve 600 for use with the cartridge valve 500 discussed above is shown in FIGS. 31-32. The device valve 600, as shown in FIG. 31 and FIG. 32, includes an outer shell, outer casing, or outer housing 602, a poppet housing 604, a valve stem cover 606, a valve stem guide 608, and a barbed fitting 610 for connecting the device valve 600 to other components of a fuel consuming device 100. The device valve 600 includes an internal biasing element (not shown in FIG. 31) for maintaining the valve in a first, closed, position when it is not coupled to a fuel cartridge 300 and a receiving portion for engaging an external member to oppose the internal biasing element and cause the valve to shift to an open second position when the device valve 600 is coupled to a fuel cartridge 300. The flow rate delivered from a fuel reservoir 310 in the fuel cartridge 300 through the connecting valve may be constant, or it may be modified within the fuel consuming device as needed. The fuel delivered at the desired flow rate may generate an internal pressure in the device valve 600, which may be transmitted across the fuel delivery system to the fuel consuming device 100. A device valve 600 may optimally have features that reduce this pressuring effect so as to reduce or prevent damage to the fuel consuming device 100 and/or its internal components.

The internal biasing element in this implementation as described below is a spring loaded cannulated rod with two end caps. A machining operation may provide different cross sections along the cannulated rod. Such cross sections allow the biasing element to shift the first, closed position to the second, open position when the device valve 600 is properly coupled to a cartridge valve 700 on a fuel cartridge 300. The biasing element along with the two end caps may have radial holes to allow the fuel to pass within the inside chamber of the cannulated rod. A machining operation, such as for example precision drilling and/or a laser cut, on the cannulated rod and the two end caps may be used to drill the hole.

An aligning feature 612 may be included on the device valve 600 for proper coupling of a device valve 600 and a cartridge valve 700. The aligning feature may be a groove or other similar feature of the device valve 600 that may be used to mechanically anchor the device valve 600 into a fuel consuming device 100 during assembly of the fuel consuming device 100. In one implementation, a device valve 600 may be assembled into fuel consuming device 100 such that an external portion 613 of the device valve 600 remains external to the fuel consuming device 100 and therefore visible as an external feature of the fuel consuming device 100. An internal portion 614 of the device valve 600 may be internal or not visible as an external feature of the fuel consuming device 100. In a similar manner, a cartridge valve 700 may be assembled into a fuel cartridge 300 by fitting an aligning feature such as a groove 702 groove GCTV into the anchoring feature of a fuel cartridge. A barbed fitting 610, which may have one or more barbs, may connect the device valve 600 with a fuel consunung component or components, such as for example a fuel cell, within the fuel consuming device 100.

A device valve 600 may be used to supply fuel to a fuel cartridge 300 or it may also be used to fill or refill the fuel cartridge 300. Therefore, the fuel may flow from the fuel cartridge 300 to the fuel consuming device 100 or from the device 100 to the fuel cartridge 300, depending on the desired application. The device valve 600 may include a metering element to control and measure the rate of fuel discharge from the fuel cartridge 300. The metering element may be a metering orifice, a porous material, a porous element, a wicking material, a flow restriction valve, or some other device or structure for controlling a flow rate.

The device valve 600 mates with a coupled cartridge valve 700 to create an external seal condition when the two valves 600, 700 are fully coupled and before the fuel flows through them between the fuel cartridge 300 and the fuel consuming device 100. The sealing component in the valve elements may be an O-ring, a sealing surface, a foamed material, or some other structure that prevents fuel from escaping through the sealed coupling. A connecting sequence between a device valve 600 and a cartridge valve 700 occurs so that an external seal condition between the two members is established and a flow path for the fuel is created. The seal element for the device valve 600, followed by the seal element for the cartridge valve 700 opening. Fuel then flows through the flow path. The device valve 600 may include one or more mechanical elements to help guide and engage with the coupled fuel cartridge valve. The mechanical elements may include, but are not limited to, grooves, ridges, notches, pins, holes, or other protuberances to enable a well-aligned fit with its counterpart mechanical element of the cartridge valve 700. The device valve 600 may also include one or more keying mechanical elements to ensure the proper combination of fuel cartridges 300 and fuel consuming devices 100 in order to prevent wrong connections where different fuels and/or different concentrations of fuel are mixed.

An end of a piece of flexible tubing may be connected to the barbed fitting 610 while the other end of the piece of flexible tubing may be connected to the fuel consuming component such that fuel may flow to or from the device valve 600 to the fuel consuming component. A connecting device valve 600 may include both plastic and non-plastic parts and fixed elements and moving elements. External action may be required to actuate the moving elements. In one implementation, a device valve 600 may be part of a fuel consumning device that is not actively powered. External action to actuate the moving elements may be provided by the connection of the device valve 600 with the fuel cartridge 300 via the force with which the fuel cartridge 300 is inserted by a user. The insertion force may actuate the biasing elements of the device valve 600.

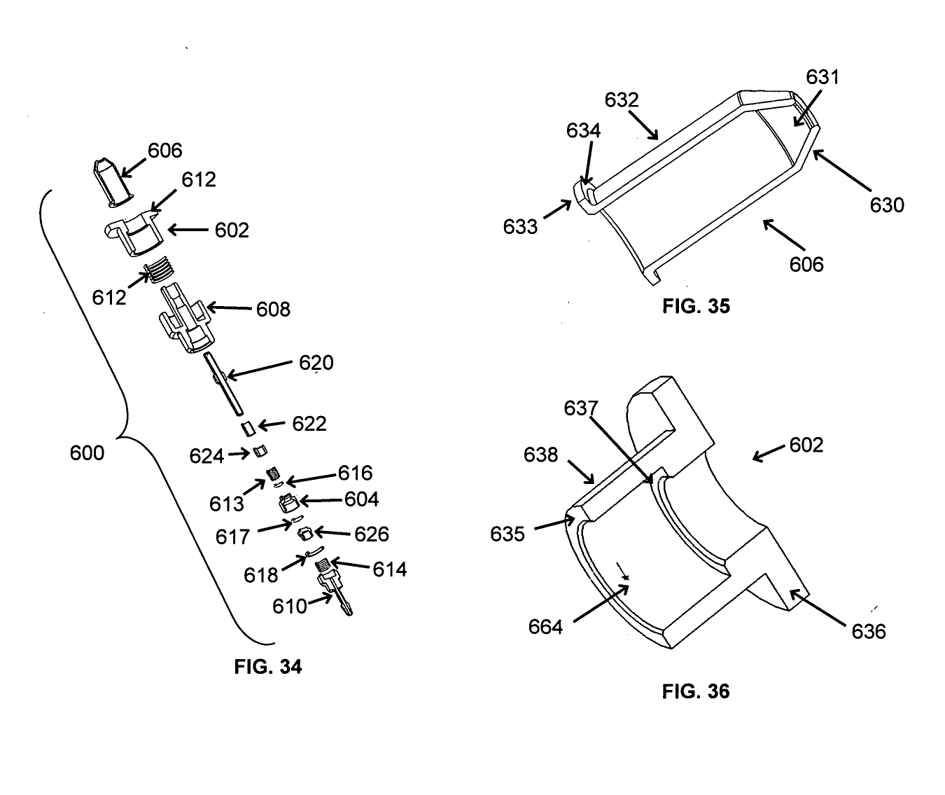

FIGS. 33 and 34 show two exploded component diagrams: an isometric view, and a cutaway isometric view, respectively, of the components included in an implementation of the device valve 600.

FIG. 33 and FIG. 34 are an exploded component diagram and an exploded component diagram showing cross sections of the various components, respectively, of a device valve 600. In addition to the valve housing 602, the poppet housing 604, the valve stem cover 606, the valve stem guide 608, and the barbed fitting 610, a device valve 600 may also include several biasing elements which may be coiled or tapered springs 612, 613, 614, several O-rings or other sealing elements 616, 617, 618, a valve stem 620, a valve stem sleeve 622, a valve stem bushing 624, and a poppet valve 626. The coiled or tapered springs in the implementation shown include a valve stem cover spring 612, a valve stem spring 613, and a poppet housing spring 614 with an O-ring for the poppet housing 617. Other parts shown in FIG. 33 and FIG. 34 include a valve stem O-ring of 616, and a barbed fitting O-ring 618 that establishes a substantially sealed condition between the barbed fitting 610 and the valve stem guide 608.

In the device valve 600 shown in FIG. 33 and FIG. 34, the depicted elements are aligned along their longitudinal axis. The parts are symmetrical in respect to the plane cross-sectioned in FIG. 34. Such an arrangement reduces manufacturing costs by providing a simplified design for these parts which may lower the process costs for a plastic injection process. An additional benefits arises from reducing the number of surfaces to be assembled. This may save time in both manual and automated manufacturing processes. The number of assembly operations, and therefore handling and manufacturing time is further reduced by a longitudinal axis assembly design. Other assemblies with parts that are not longitudinally symmetrical are also possible.

FIG. 35 shows an isometric cross section view of the valve stem cover 606 of a device valve 600, showing a conical end 630, an internal conical and annular chamber 631, a valve stem cover neck 632, a valve stem cover flange 633, and a ridge 634. Because the valve stem cover 606 may reside external to a fuel consuming device 100 and may be therefore exposed to various forces as well as repeated connections and disconnections with a cartridge valve, the valve stem cover 606 may be constructed of a strong or resilient material. For example, the design considerations taken into account for the design of the valve stem cover 606 may include passing a preliminary connection cycling test that may include more than 1000 connections between the device valve 600 and a fuel cartridge 300. Because of the aforementioned strength and durability concerns, the valve stem cover 606 may be constructed of stainless steel 304 or stainless steel 316 or another comparably inert and durable material. In addition, the valve stem cover 606 described herein may physically create a seal condition when it is connected to and disconnected from a variation of a cartridge valve 700.

During coupling with a fuel cartridge valve 700, the valve stem cover 606 may form a seal with a compressible part, that may be made of rubber, in the fuel cartridge valve 700. Use of a metallic material for the valve stem cover 606 may provide a good seal compatibility with the counterpart compressible structure of a fuel cartridge valve 700. An example of the manufacturing process that may be used to build this variation of the valve stem cover 606 may be as follows. A bar stock of the material is bored and cleaned to the specified internal diameter. Then the bar stock is cut to the desired dimension of the valve stem cover 606. Radial shaping may be done on a mechanical lathe. The valve stem cover 606 dimensions may optionally be in the following ranges: external diameter of the valve stem cover flange 633 between approximately 8 and 10 mm, external diameter of the valve stem cover neck 632 between approximately 5 and 7 mm, wall thickness of the valve stem cover neck 632 between approximately 1 and 3 mm, and total length of the valve stem cover 606 between approximately 10 and 20 mm.

An isometric cross section view of a valve housing 602 of a device valve 600 is shown in FIG. 36, which also shows a first and a second valve housing flange 635, 636, an inner face 637, an outer cylindrical face 638, a flat face 639, and hollow chamber 664. The dimensions of the valve housing 602 may be constrained by the need for dimensional stability on the outer cylindrical face 638. In addition, the outer cylindrical face 638 may have specific features of design for the assembly with the valve stem guide 608. The valve housing 602 and the valve stem guide may optionally be assembled using ultrasonic welding. The valve housing 602 may have different external shapes of the second valve housing flange 636 to be anchored in a internal architecture or design of a fuel delivery system for a fuel consuming device 100 to which this device valve 600 may be assembled. The valve housing 602 dimensions may optionally be in the following ranges: external diameter of the second valve housing flange 636 between approximately 14 and 20 mm, external diameter of the outer cylindrical face 638 between approximately 10 and 13 mm, wall thickness of the outer cylindrical face 638 between approximately 1 and 3 mm, total length of the valve housing 602 between approximately 5 and 15 mm.

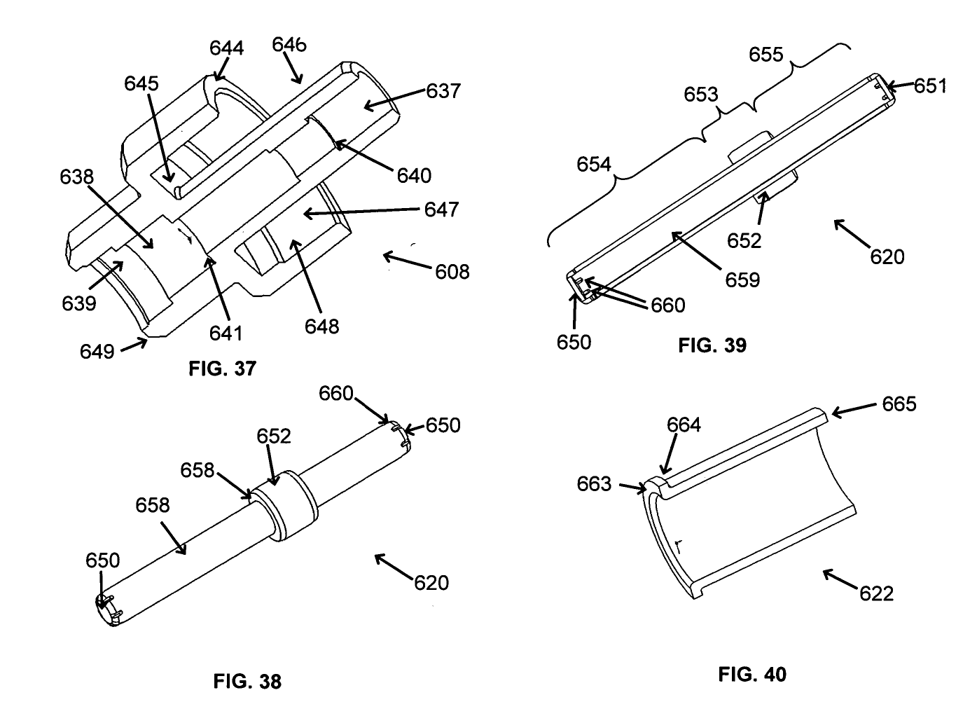

FIG. 37 shows an isometric cross section view of a valve stem guide 608 that includes a first internal cylindrical chamber 637, second internal cylindrical chamber 638, third internal cylindrical chamber 639, a first inner flat face 640, a second inner flat face 641, a front flat face 644, a flat seat 645, a valve stem guide neck 646, an annular hollow chamber 647, an internal cylindrical face 648, and a second flat face 649. The valve stem guide 608 may be part of the internal architecture or design of a fuel delivery system for a fuel cell, and/or a fuel cell system for a fuel cell, and/or a micro fuel cell power unit. The valve stem guide 608 forms the main body of the device valve 600, which may join the external and internal parts of the device valve 600 and also may encase all or part of the elements of the variation of the device valve 600. The dimensional stability may be desirable in both internal and external cylindrical faces. In addition, welding features may be used to join the valve stem guide 608 with a barbed fitting, such as for example the barbed fitting 610 and a valve housing 602. Other elements of the device valve 600 may be press fitted into internal cylindrical chambers 637, 638, 639 of the valve stem guide 608. For example, a poppet housing 604 is press fitted into the second internal cylindrical chamber 638 of the valve stem guide 608. The valve stem guide 608 dimensions may optionally be in the following ranges: external diameter between approximately 12 and 20 mm, external diameter of the neck 646 between approximately 4 and 7 mm, general specification for all or some wall thicknesses of the stem guide between approximately 1 and 3 mm, total length of the valve stem guide 608 between approximately 15 and 25 mm.

FIGS. 38-39 show an isometric component view and an isometric cross section view of a valve stem 620, respectively. The valve stem 620 includes a first end cap 650 and a second end cap 651, an annular ring 652, a ring thickness dimension 653, a first valve stem section 654, a second valve stem section 655, a valve stem neck 657, a flat face 658, an internal chamber 659, radioed edges 660 at each of the first end 650 and the second end 651, and one or more pass-through holes 661 at each of the first end 650 and the second end 651. The pass-through-holes 661 penetrate to the internal chamber 659, and may be aligned approximately perpendicular to the axis of the valve stem. An assembly procedure for a valve stem 620 may be as follows. A cannulated rod may be used so that the internal diameter may only require a cleanup operation. The pass-through holes 661 of, in one example, approximately 0.25 mm to 0.35 mm, may be drilled or laser cut. Two ends caps 650, 651 may be created with a step shoulder, inserted at the ends of the cannulated rod, and laser welded to create the radioed edge 660. An annular ring 652 may be created by initially using an oversized cannulated rod with the same external diameter as the diameter of the annular ring 652. The cannulated rod may be machined down in a lathing or a comparable machining operation to the desired dimension on the first and second sections of the valve stem 620. Alternatively, the annular ring 652 may be obtained by using an annular ring with the desired external diameter, the desired length or thickness 653, and the internal diameter of the cannulated rod to be used. This annular ring 652 may be press fitted into the cannulated rod and laser welded in such way that the dimensions of sections 654 and 655 are left on both respective sides of the annular ring 652. To ensure the precise dimensions 654 and 655, the manufacturing process may include the use of a fixture, a gauge, and/or a tool with a stopper with one driving dimension, either 654 or 655, so the annular ring 652 may be inserted until it contacts the stopper, and the annular ring 652 may be laser welded to the cannulated rod therefrom. Straightness of the cannulated rod after the complete assembly of this variation of the valve stem 620, dimensional stability of the thickness of the annular ring 652, and flatness of the first and second end caps 650, 651 and the flat face 658 may influence functionality of the connection device valve 600. Therefore, a durable, rigid material, such as for example stainless steel 304 or stainless steel 316 may be used for the valve stem 620. The valve stem 620 dimensions may optionally be in the following ranges: external diameter of the annular ring 652 between approximately 2 and 5 mm, external diameter of the neck 657 between approximately 2 and 4 mm, wall thickness of the neck 657 between approximately 0.2 and 0.75 mm, and total length of the valve stem 620 between approximately 15 and 25 mm.

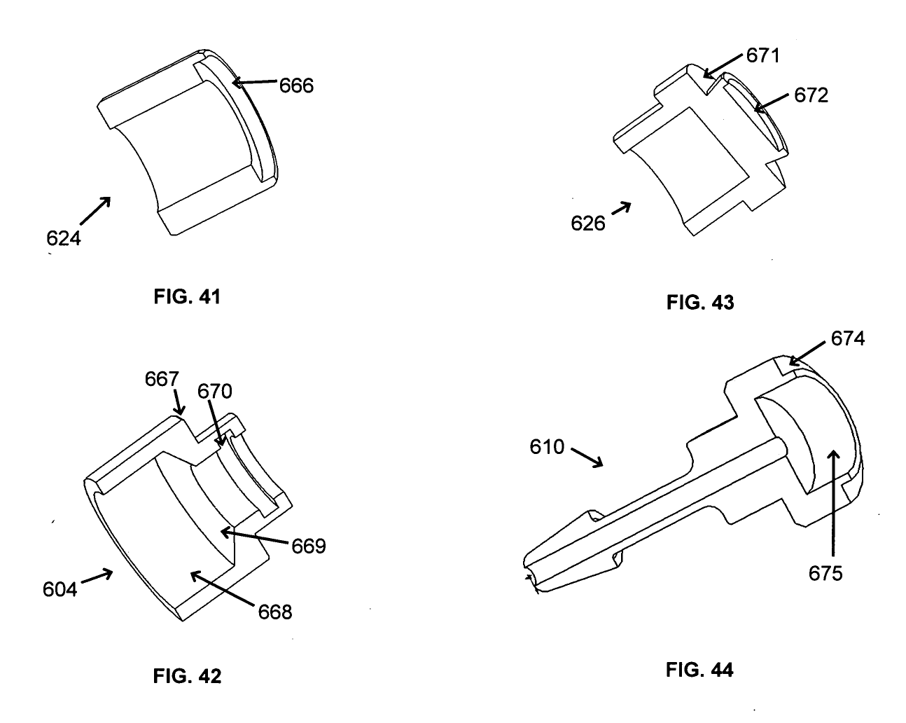

FIG. 40 and FIG. 41 depict isometric cross-sectionals view of a valve stem sleeve 622 and a valve stem bushing 624, respectively, of a connecting device valve 600. The valve stem sleeve 622, which includes a flat face 663, a flange 664, and a flangeless face 665, may be axially slid into the valve stem 620. The total longitudinal dimension of the valve stem sleeve may influence functionality of the device valve 600, since that length may determine the maximum stroke or displacement of the valve stem 620. The valve stem sleeve 622 may be constructed out of a strong, durable, rigid material such as for example stainless steel 304 or stainless Steel 316. Following the assembly procedure described above, the valve stem bushing 624, which includes a boss cut face 666, may be press fitted into the neck 657 of the valve stem 620 until it contacts the stem valve sleeve 622. The valve stem bushing 624 dimensions may optionally be in the following ranges: external diameter, between 2 and 5 mm; wall thickness, between 1 and 3 mm; total length, between 2 and 10 mm.

Isometric cross-sectional views of a poppet housing 604 and a poppet valve 626 are shown in FIGS. 42-43, respectively. The poppet housing 604, which includes FFH 667, CH 668, ICF 669, and internal annular groove 670, may optionally have dimensions in the following ranges: external diameter between approximately 4 and 10 mm, wall thickness between approximately 1 and 3 mm, and total length between approximately 4 and 10 mm. The poppet valve 626, which includes inverse conical groove 671 and a convex face 672 may optionally have dimensions in the following ranges: external diameter, between approximately 3 and 10 mm, wall thickness between approximately 1 and 3 mm and total length between approximately 3 and 10 mm.

FIG. 44 shows an isometric cross section view of a barbed fitting 610 of a connecting device valve 600. A material such as, for example, stainless steel 304 or stainless steel 316 that has acceptable dimensional stability and ability to be formed into very small parts may be used in the manufacture of the barbed fitting 610. The barbed fitting, which includes an annular boss 674, and a cylindrical cavity 675, may be welded by ultrasonic welding to the valve stem guide 608. The barbed fitting 610 dimensions may optionally be in the following ranges: external diameter between approximately 5 and 10 mm, wall thickness between approximately 1 and 3 mm, and total length between approximately 10 and 20 mm.

An assembly process for a connecting device valve proceeds as follows. The stem valve 620 may be axially inserted into the valve stem guide 608 in such way that the end cap 650 of the stem valve 620 enters a cylindrical cavity 637 of the valve stem guide 608. The stem valve 620 may be pushed into the cylindrical cavity 637 of the valve stem guide 608 until a flat face 658 of the stem valve 620 contacts an inner flat face 640 of the valve stem guide 608. Next, the valve stem sleeve 622, which has a flangeless face 665, axially slides into the valve stem 620 in such a way that the flangeless face 665 is introduced first until it contacts the flat face 658 of the stem valve 620. Next, a boss-cut face BCF of the valve stem bushing 624 enters first into a neck N of the valve stem 620. The valve stem bushing 624 may be press fitted into the neck 657 of the valve stem 620 until it contacts a flat face 663 of the flange 664 of the stem valve sleeve 622. Next, the valve stem spring 613 slides into the neck N of the valve stem 620 until one end SE contacts the stem valve bushing 624.

In a separate operation, the valve stem O-ring 616 may be inserted in an internal annular groove 670 of the poppet housing 604. This assembly of the poppet housing 604 with the valve stem O-ring 616 may be press fitted into a second cylindrical cavity 638 until a flat face 667 of the poppet housing 604 contacts an inner flat face 641 of the valve stem guide 608. In a third operation, the poppet housing O-ring 617 may be inserted in an inverse conical groove 671 of the poppet valve 626. This assembly of the poppet valve 626 with the poppet housing O-ring 617 may be inserted into a cylindrical cavity cylindrical cavity in such way that the poppet housing O-ring 617 contacts an inner conical face 669 of the internal cylindrical cavity 668 of the poppet housing 604.

In a further step of an assembly process of this device valve 600, the poppet housing spring 614 may be inserted in a cylindrical cavity 675 of the barbed fitting 610. Next, the barbed fitting O-ring 618 can then be inserted in an annular boss 674 of the barbed fitting 610. The assembly of the barbed fitting O-ring 618, the poppet housing spring 614, and the barbed fitting 610 may be inserted into the third cylindrical cavity 639 of the valve stem guide 608 until the flat face 658 is flush with the flat face 649 of the valve stem guide 608. After this assembly operation, the barbed fitting 610 may be ultrasonically welded by method to the valve stem guide 608. Various methods of welding may be used in this assembly operation. Therefore, depending upon the method of welding that is utilized, various welding features may be considered for the design of the areas of welding contact between the barbed fitting 610 and the valve stem guide 608. Next, a conical end 630 of a valve stem cover 606 may be axially inserted through a bigger cylindrical cavity or hollow chamber 634 into the valve housing 602. An inner face of a ridge 634 of the valve stem cover 606 contacts an inner face 637 of the valve housing 602. The stem valve cover spring 612 slides into the valve stem guide neck 646 of the valve stem guide 608. One end of the stem cover spring 612 may sit on top of a flat seat 645 of the valve stem guide 608.

The assembly of the valve stem cover 606 and the valve housing 602 may be inserted into the annular hollow chamber 647 of the valve stem guide 608, so an outer cylindrical face 638 of the valve housing 602 may contact an inner cylindrical face 648 of the annular hollow chamber 647 of the valve stem guide 608. The insertion of this assembly may have a limitation on the length or dimension that this assembly needs in order to be inserted into the annular hollow chamber 647 of the valve stem guide 608. This limitation may be determined by a design of the welding features of the valve stem guide 608 and the valve housing 602, which may create an opposing resistance to the insertion when a flat face 639 of the valve housing 602 approaches the flat seat 645 of the valve stem guide 608. In a manufacturing process, a method to reliably calibrate a stroke or insertion length 695 that the valve housing 602 needs to penetrate into the annular hollow chamber 647 of the valve stem guide 608 may be the use of a calibrated spacer, a machined and calibrated fixture, or a calibrated mechanical tool, that may set a required space, length, or distance 654, shown in FIG. 39, between a valve housing flange 635 of the valve housing 602 and a front flat face 644 of the valve stem guide 608. Next, the valve housing 602 may be welded to the valve stem guide 608 by an ultrasonic welding method.

The distance 654, shown in FIG. 39, between the valve housing flange 635 of the valve housing 602 and the front flat face 644 of the valve stem guide 608 may also influence the thickness of the hard casing or housing of the internal architecture or design of a fuel delivery system for a fuel cell, and/or a fuel cell system for a fuel cell, and/or a micro fuel cell power unit to which a device valve 600 may be assembled. The distance 654 may set the dimension or thickness of the anchor wall of such internal architecture or design of a fuel delivery system for a fuel cell, and/or a fuel cell system for a fuel cell, and/or a micro fuel cell power unit.

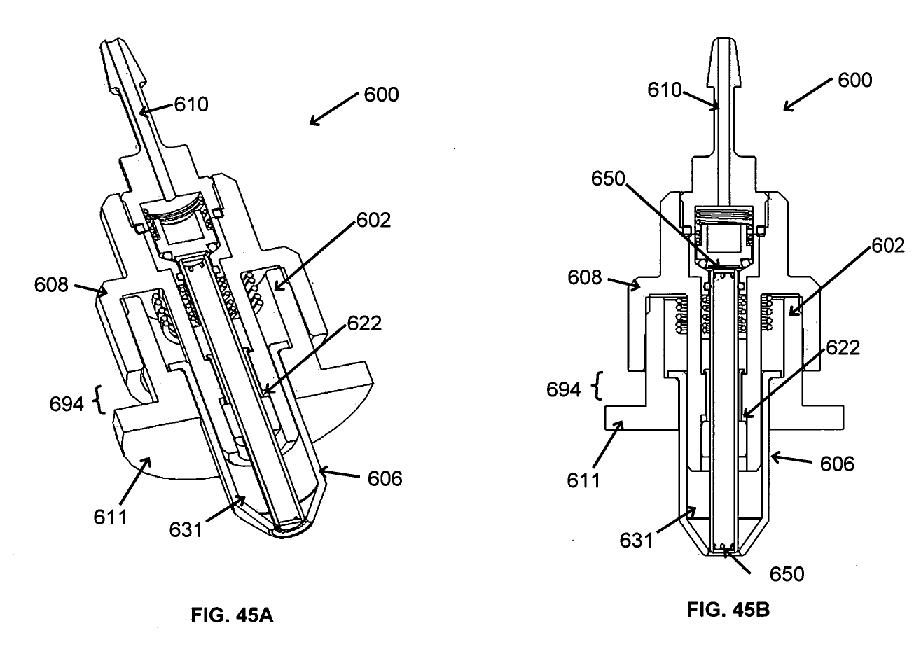

The manufacturing process described above provides assembly of the device valve 600, illustrated with a cross section view in FIG. 45A. Next, the device valve 600 may be assembled with a fuel delivery system for a fuel cell, and/or a fuel cell system for a fuel cell, and/or a micro fuel cell power unit. Other assembly methods can alternatively be utilized.

In one implementation, an absorbent material may be used in the internal conical and annular chamber 631 created between the valve stem 620 and the valve stem cover 606, as shown in FIG. 45A and FIG. 45B. An acceptable material for this application may be POREX Porous Plastic which can be found from POREX® Technologies (Fairburn, Ga.). POREX® Technologies offers PE (polyethylene) in extra fine, fine, medium and coarse grades and PP (polypropylene) in medium and coarse grades. A hydrophilic type of POREX® Porous plastic may be used, giving the benefit of absorbency of drops of fuel that may escape as the connecting device valve 10 connects and/or disconnects from a fuel cartridge.

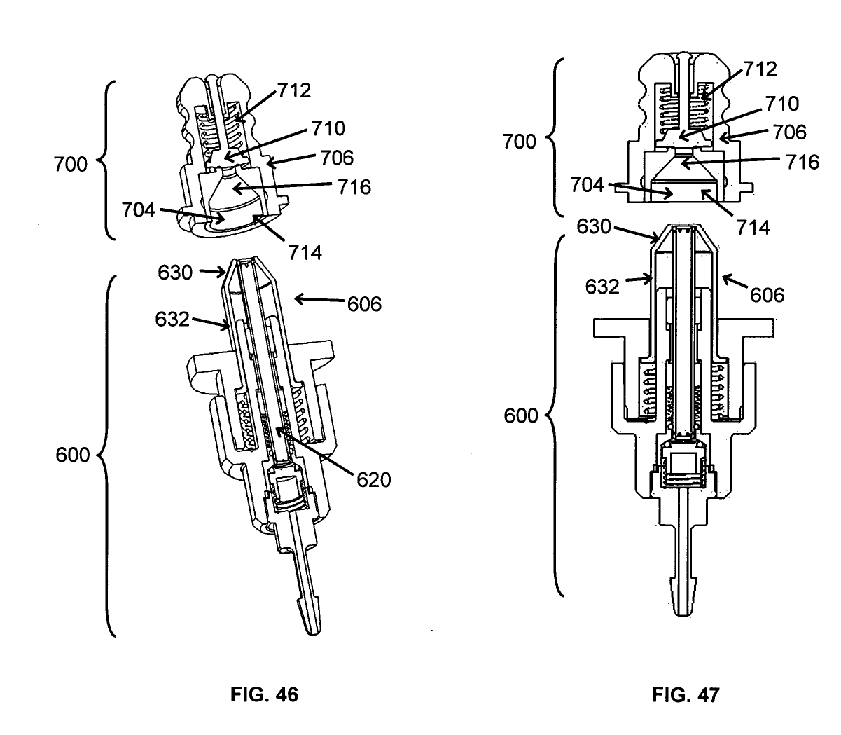

FIG. 46 shows a cross section view of a device valve 600 with a fuel cartridge valve 700. The receiving fuel cartridge valve 700 may optionally include a soft material (referred to herein as a deformable ring 704) to receive a device valve 600. The deformable ring 704, which may be made of rubber or some other compressible material, creates a seal condition when it is contacted by a connecting counterpart of the device valve 600, a hard case (being referred in this variation as fuel cartridge valve body 706), a biasing element (referred to herein as a fuel cartridge valve poppet 60), and a valve spring (referred to herein as a fuel cartridge poppet spring 712). This deformable ring 702 may be similar to the deformable ring 512 discussed above in regards to other implementations of cartridge valves. The contacting counterpart may be a valve stem cover 606, which contacts the deformable ring 702 of the fuel cartridge valve 700 to create a seal condition between them, so that fuel may flow safely between the fuel cartridge 300 to the fuel delivery system for a fuel consuming device 100.

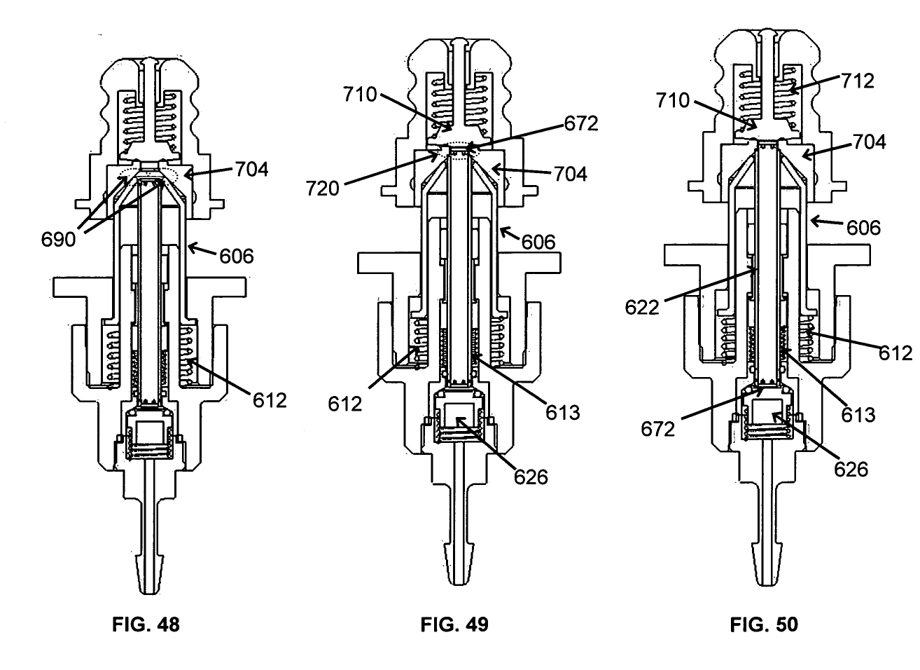

A connecting sequence between a fuel cartridge valve 700 and a device valve 600 is shown for this implementation in FIGS. 46-53. Before the two connecting elements, the connecting device valve 600 and the fuel cartridge valve 700, enter in contact, their respective valves remain closed. A fuel path has not been created yet. As the fuel cartridge valve 700 approaches the connecting device valve 600, the neck 632 of the valve stem cover 606 of the connecting device valve 600 enters the first deformable ring neck 714. The first deformable ring neck 714 may have substantially parallel sides. A mutual seal between both elements has not yet been created because this insertion may be a slip fit, with a radial clearance between the valve stem cover neck 632 of the device valve 600 and the first deformable ring neck 714. The clearance between the deformable ring neck 714 and the valve stem cover neck 632 may be in the range of approximately 0.1 mm to 0.2 mm. As the fuel cartridge 300 approaches and moves toward the device valve 600, the device valve 600 and the fuel cartridge valve 700, make contact for the first time as shown in FIG. 47. The conical head 630 of the valve stem cover 606 of the device valve 600 will contact the conical deformable ring neck 716, as shown in FIG. 48. A mutual seal 690 between the two connecting valves is thus created. As the valve stem cover 606 pushes against the conical deformable ring neck 716, the deformable ring 704 may deform slightly due to the pressure force the valve stem cover 606 applies against it. The valve stem cover 606 may also move slightly backwards, which in turn, may compress a valve stem cover spring 612, as shown in FIG. 49. As the valve stem cover 606 pushes further against the conical deformable ring neck 716, the valve stem cover spring 612 continues to compress, and the biasing element or valve stem 620 of the device valve 600 enters the annular deformable ring neck 720. Because the diameter of the valve stem 620 may be slightly bigger than the diameter of the annular deformable ring neck 720, a second seal condition 692 may be created. The fuel cartridge valve 700 keeps moving toward the device valve 600 which causes the valve stem cover 606 to move backwards, further compressing the spring 612. This stage of the connecting sequence may reach a point where the end cap 651 contacts the fuel cartridge valve poppet 710, as shown in FIG. 49.

FIG. 50 shows an intermediate stage of the connecting sequence. The fuel cartridge valve 700 moves toward the device valve 600. The valve stem cover 606 continues to retreat, thereby compressing the spring 612. The tension force of the fuel cartridge poppet spring 712 reaches a point at which it exceeds the combined or equivalent tension force of the springs 612, 613, and 614, so the valve stem 620, along with the valve stem sleeve 622 and the valve stem bushing 624 move backwards, thereby compressing the valve stem spring 613. In a further approach of the fuel cartridge valve 700 towards the device valve 600, the end cap 650 of the valve stem 620 contacts the convex face 672 of the poppet valve 626. At this point, further movement of the valve stem 620 backwards opens the poppet valve 626, and consequently causes the device valve 600 to open.

FIG. 51 shows the device valve 600 in a fully open configuration. The tension force of the fuel cartridge poppet spring 712 continues to exceed the combined or equivalent tension force of the springs 612, 613, and 614, so valve stem 620 moves backwards until the flat face 658 of the annular ring 652 of the valve stem 620 contacts the inner face 640 of the valve stem guide 608. At this stage of the connecting sequence, the springs 612, 613, and 614 reach their maximum deformation allowed. The factor that may determine the maximum stroke or displacement of the springs 612, 613, and 614, is the length of the valve stem sleeve 622.

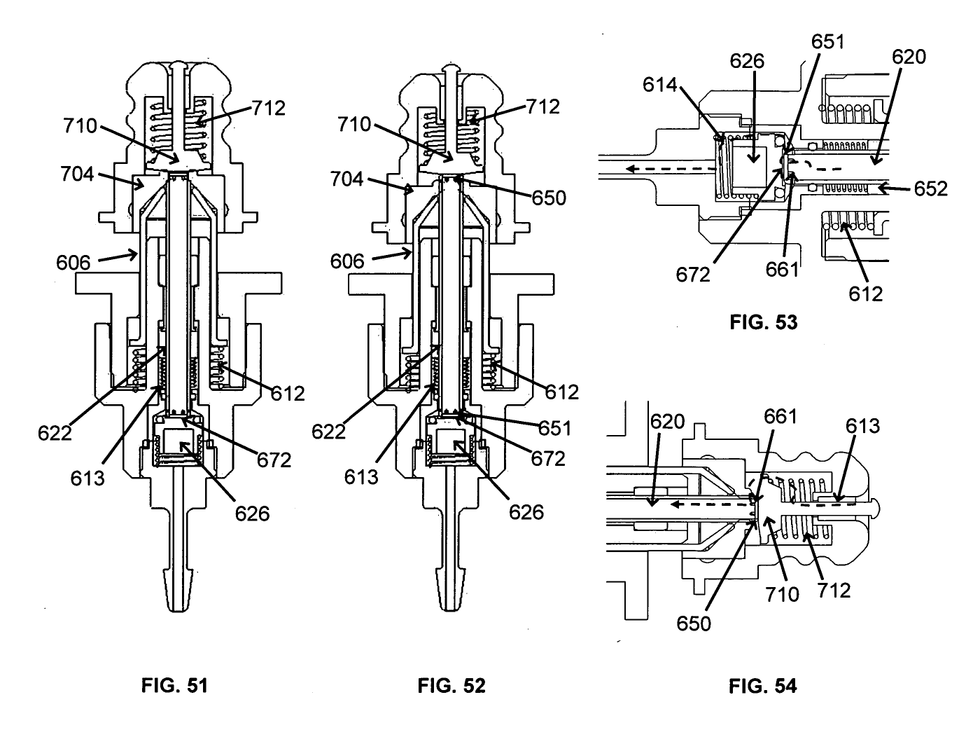

FIG. 52 shows the fuel cartridge valve 700 totally open to its full extent. The valve stem 620 may not move any further backwards because it may be impeded by the opponent element of the valve stem guide 608 (i.e., in this variation, the flat face 640). As such, the springs 612, 613, and 614 may not compress any further. Thus, as the fuel cartridge valve 700 moves further towards the device valve 600, the fuel cartridge valve 700 is caused to open because the tension force of the fuel cartridge poppet spring 712 is overcome by the force exerted by the fuel cartridge being pushed toward the device valve 600. The fuel cartridge poppet valve 710 retreats and compresses the fuel cartridge poppet spring 712 to open the fuel cartridge valve. The fuel then flows from the fuel cartridge through the fuel cartridge valve 700 to the fuel consuming device through the device valve 600. The fuel may flow from the fuel cartridge valve 700 to the device valve 600 through the valve stem 620. The fuel may enter the pass-through holes 661 by the end cap 651, may fill the internal chamber 659 of the valve stem 620, and exit through the radial holes by the end cap 650. The number, size, and shape of the pass-through holes 661 may vary depending of the flow rate desired. In one implementation, the fuel cartridge delivers a fuel flow rate in the range of approximately 1 mL (milliliters) per hour to 12 mL per hour.

FIG. 53 and FIG. 54 show a detailed cross section view of the device valve 600 fully open and a detailed cross section view of the fuel cartridge valve 700 fully open, respectively. A path for the fuel is shown in FIG. 44G and FIG. 44H, respectively. It is desirable for the connection and/or disconnection between the device valve 600 and the fuel cartridge valve 700 to have zero leakage throughout the complete fuel flow path. The fuel may be delivered from the fuel cartridge to the fuel consuming device through the device valve 600 in any orientation. The dotted line in FIG. 53 shows the path of fuel in the device valve 600. Fuel travels down the valve stem 620 to the second end cap 651, passes out of the internal chamber 659 of the valve stem 620 through the pass-through holes 661 in the end cap past the convex face 672 of the poppet valve 626, and on to the fuel consuming device. In the cartridge valve, fuel passes the cartridge poppet 710, enters the first end cap 650 through the pass-through holes 661, and travels down the valve stem 620 toward the device valve 600.

The device valve 600 may provide a proper aligrunent with the fuel cartridge valve 700 using one or more aligning mechanical features including, but not limited to, grooves, corresponding ridges, pins, holes, etc.

Another implementation of a device valve 900 and a fuel cartridge valve 800 is illustrated in FIGS. 55-62. FIG. 55 shows a fuel cartridge valve 800 and a device valve 900 which may be coupled together 901. In this implementation the device valve 900 is a female valve and the fuel cartridge valve 800 is a male valve. The fuel cartridge valve 800 has a sliding body or poppet 802 biased by a poppet spring 804. When the fuel cartridge valve 800 is closed, the poppet 802 contacts only a conical external sealing interface 806 that may be made of an absorbent material like the deformable ring 512 described above. The flat flange 810 of the poppet 802 may have a clearance gap, that may optionally have a dimension of approximately 0.2 mm with the valve body 812, so that the poppet 802 contacts do not provide any mechanical redundancy and no degrees of freedom on its movement are compromised.

A main body 902 of the device valve 900 enters the fuel cartridge valve 800 and produces a seal condition by having a semi-spherical area 904 in contact with the semi-spherical absorbent material 806. A sliding body or actuating pin 906 may be biased by an actuating pin spring 910. The actuating pin outer surface 912 may be convex so it matches the corresponding concave surface of the poppet 802 in the fuel cartridge valve 800. As the actuating pin 906 is pushed toward the poppet 802, the fuel cartridge valve 800 opens and allows fuel to flow from the fuel cartridge to the portable device fuel cell through the coupler 901.

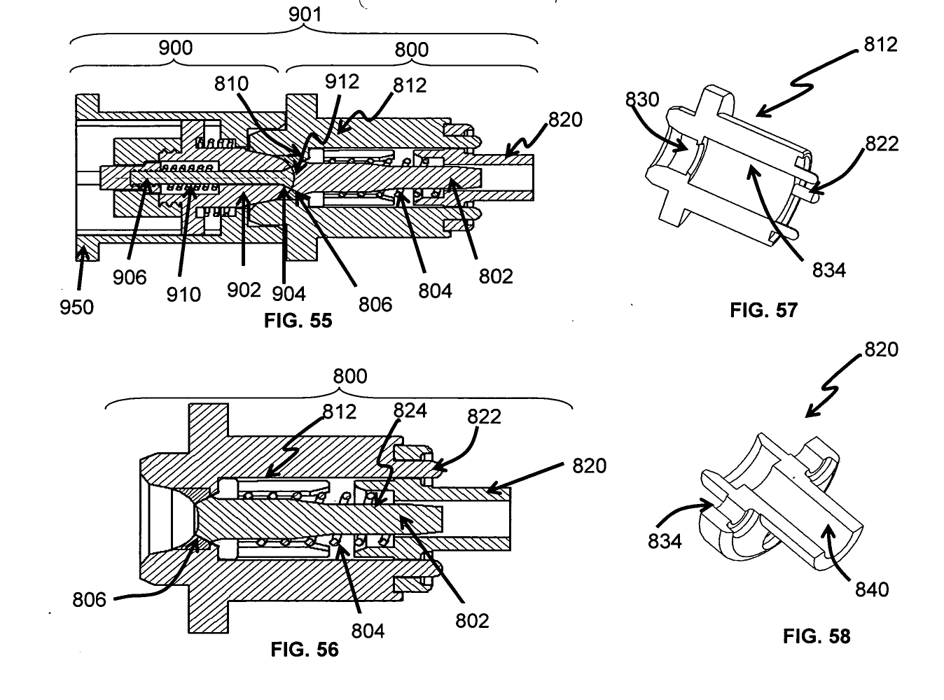

FIG. 56 shows a cross-section of a fuel cartridge valve 800. The fuel cartridge valve 800 may include a back cap 820 that is attached to a back side of the valve body 812 using four pins 822 as centering guides to assemble it. Once the back cap 820 is positioned properly, a welding method, such as ultrasonic welding or heat welding, may be used to weld the back cap 820 to the valve body 812. The back cap 820 may serve to retain the poppet spring 804 and also may provide alignment to the stem 824 of poppet 81. FIG. 57 and FIG. 58 show isometric cross-section views of the valve body 812 and the back cap 820, respectively. The valve body 812 may includes an external sealing interface 830 that is adapted to mate in a sealed condition with the semi-spherical area of the coupling member 904 of the device valve, forming an external sealed condition. An annulus 832 may be also provided leading from the external sealing interface to the valve body interior 834. The pins 822 shown in FIG. 57 may be used for ultrasonic welding to assemble the valve as described above. FIG. 58 shows a cross-sectional view of the back cap 820. This part of the valve provides a spring support 836 upon which the poppet spring 804 may be based such that the poppet spring may bias the poppet 802 against the annulus 832 to form an internal seal that closes the device valve 800. The back cap 820 also includes a poppet guide channel 840 that helps to maintain alignment of the poppet and that provides a flow channel for fuel from the fuel reservoir 310 which is connected to the poppet guide channel by tubing or other fluid conducting means.

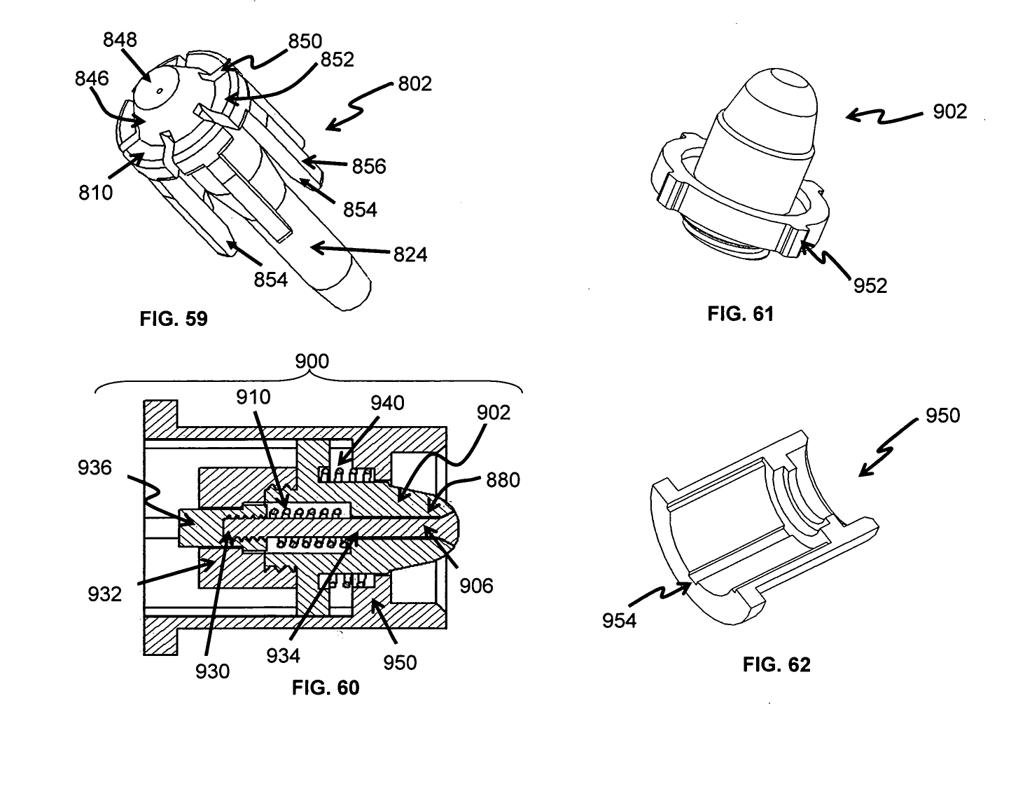

A poppet 802, as shown in FIG. 59, may include a poppet head 846 that is shaped substantially like a truncated cone with a concave cavity 848 formed at the narrow end. The concave cavity 848 allows the poppet head 848 to create an internal seal when the poppet is biased against the internal sealing interface 806, which in this implementation is also shaped like a truncated cone with the larger cross-sectional area opening of the truncated cone directed toward the poppet head 846. Biasing of complementary conical surfaces against one another forms a seal. The concave cavity 848 is complementary to a corresponding convex head surface of the coupling member 902 in the portable device valve 900.

Fuel is allowed to flow through gaps 850 between two or more separated flanges 852, of which there are six in FIG. 59. Fuel is allowed to flow through the gap 850 or clearance created between adjacent flanges 852. Each flange has a long stem 854 with a cylindrical long face 856 that helps align the poppet 802 through the inside cylindrical chamber 834 of the valve body 812. In some variations, the aligning stems 854 do not contact the inner cylindrical face of the valve body 812, in which case a clearance gap, for example of approximately 0.2 mm may be provided. If the poppet spring 804 introduces a minor bias on the alignment of the poppet 802, the aligning stems 854 absorb the misalignment and help the poppet 802 to move accordingly while being aligned with the actuating member 906 in the device valve 900.

Another implementation of a device valve 900 is depicted in FIG. 60 and includes threaded joints 930 between a coupling member 902 and a set back body 932 and between an actuating member 906, which may be an actuating pin that includes an actuating head 912 and an actuating stem 934, and a set ejector back 936. The coupling member 902 may be biased by a front body spring 940, which recesses when it enters in contact with the external semi-spherical surface of the absorbent material in the fuel cartridge valve 800. The set ejector back 936 may be biased by back ejector spring 910 when the actuating pin 906 is pushed forward against the poppet 802 concave head. Fuel flows from the fuel cartridge valve 800 to the device valve 900 through an annular area 880 created between an actuating pin stem 934 of the actuating pin 906 and the inside cylindrical surface of the set front body 902. The radial gap between both elements may optionally be between approximately 0.1 mm and 0.15 mm. Fuel continues its path to the fuel consuming device through the annular gap, which may optionally be in the range of approximately 0.1 mm to 0.15 mm, that is created between the external cylindrical wall of the set ejector back 936 and the set back body 932.

FIG. 61 and FIG. 62 show an isometric view of a set front body 902 and an isometric cross-section view of the device valve body 950, respectively. These figures show corresponding aligning features between the set front body 902 and the device valve body 950. Several flanges 952 of the set front body 902 are shown in FIG. 61. Corresponding grooves 954 of the device valve body 950 are shown in FIG. 62. The aligning features guide a set front body 902 inside the cylindrical chamber 956 of a device valve body 950. In this variation, the dimensions of a device valve body 950 may be similar to those of a fuel cartridge valve body 504 as discussed above. Fuel may be conducted through the annular area left between the internal diameter of the chamber 956 of the device valve body 950 and the external diameter of the cylindrical neck 960 of the set front body 902. This cylindrical clearance may be on the order of approximately 0.05 mm to 0.15 mm.

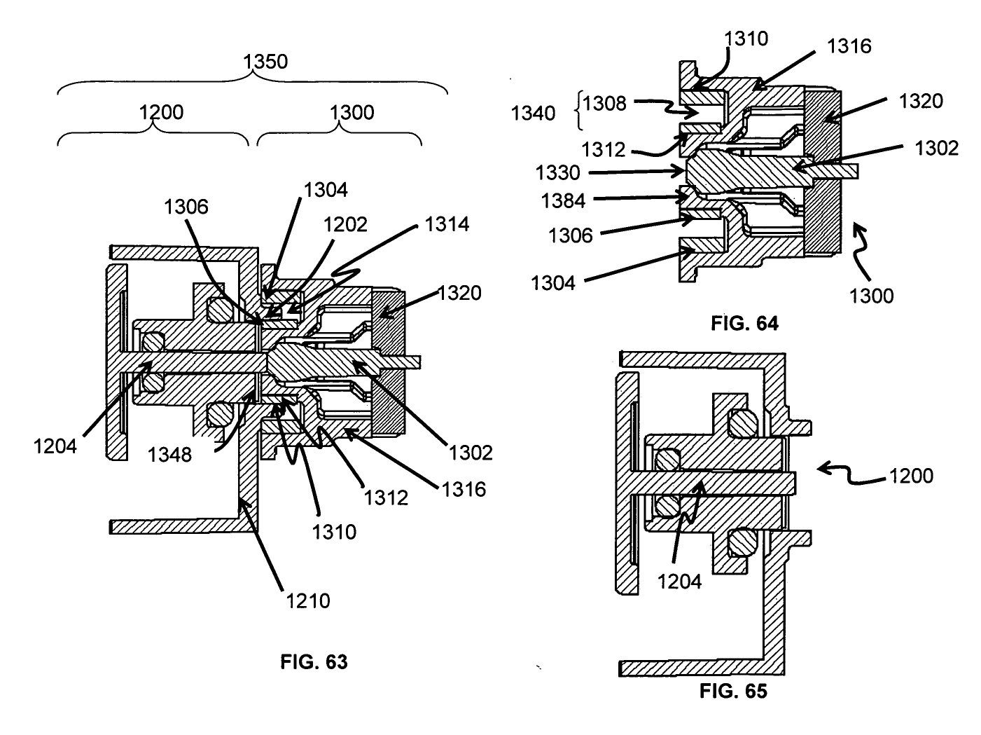

FIG. 63 shows another implementation of coupled valves in which a device valve 1200 is a male valve and a fuel cartridge valve 1300 is a female valve. This implementation includes a different configuration of the entering nipples 1202, biasing element of the poppet 1302, and absorbent material 1304 and seal material 1306 than the subject matter described above. FIG. 64 and FIG. 65 show detailed cross-sectional views of the fuel cartridge valve 1300 and the device valve 1200, respectively. As shown in FIG. 63, the nipples 1202 of the device valve 1200 enter a cylindrical annular cavity 1308 in the fuel cartridge valve 1300. The nipples 1202 first contact with outer cylindrical face 1310 of a rubber seal ring 1306 that is attached to an inner cylindrical face 1312 of an annular cavity 1314 in the valve body 1316.

A poppet 1302 may be made of a rubber material that is substantially inert to the fuel that flows from the fuel cartridge 300 to a fuel consuming device 100 through the coupled valves (cartridge valve 1300 and device valve 1200). Some examples of rubber materials suitable for poppet 1302 include ethylene propylene rubber, ethylene propylene diene methylene terpolymer (EPDM), Buna N Nitrile, and NEOPRENE® DuPont). These materials may easily be compressed to provide the biasing force required to open the fuel cartridge valve 1300. FIG. 63 depicts a cross-section view of the coupler 1201 and also shows the location of the rubber poppet 1302 within this coupler configuration when actuating pin 1204 is in contact with the rubber poppet 1302, in an immediate instant prior to opening of the fuel cartridge valve 1300. In a further instant, if the actuating pin 1204 continues moving forward against the rubber poppet 1302, it pushes the head of the rubber poppet 1302. Since the rubber poppet 1302 may be confined between a poppet seat 1320 and the internal walls of the valve body 1316, it deforms in a direction perpendicular to the movement of the actuating pin 1204, and compresses in the direction of the movement of the actuating pin 1204. As a result, fuel cartridge valve 1300 opens allowing fuel to flow from the fuel cartridge 300 to the fuel consuming device 100 through the coupler 1350 herein described.

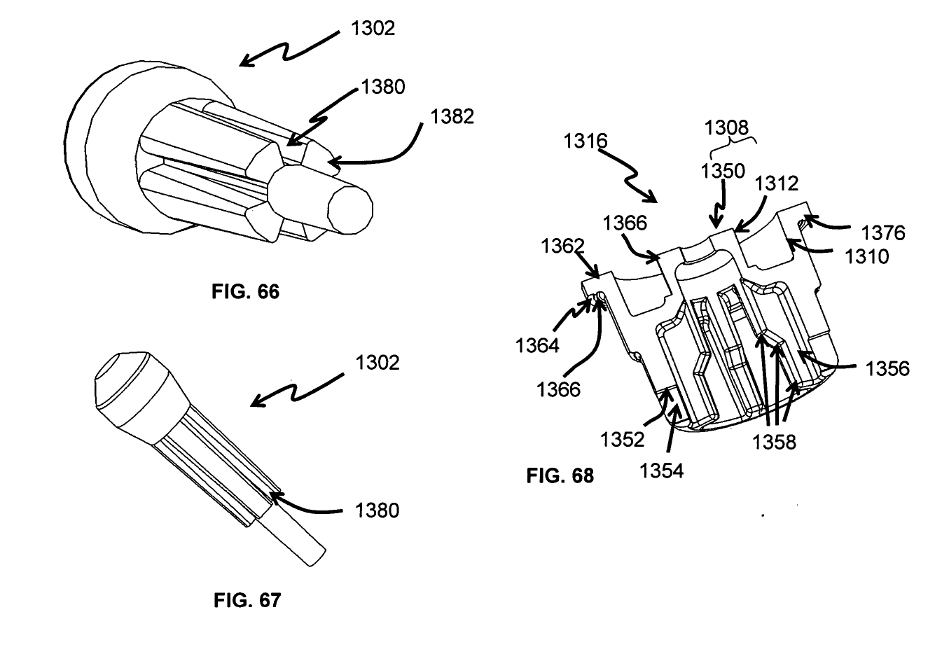

FIG. 66 and FIG. 67 are views of the poppet 1302 that illustrate its shape and some mechanical features. The poppet 1302 may be made of a compressible material, such as for example a rubber-type material including but not limited to NEOPRENE® with a hardness in a range of approximately A-Shore 55 to A-Shore 70. This poppet 1302 is at least somewhat compressible. This compressibility allows the poppet 1302 to open or close the cartridge valve when it may be required in the connection or disconnection procedure of the fuel cartridge valve 1300 with the device valve 1200. FIG. 66 shows in detail the design of such a poppet valve 1302 with hollow longitudinal channels 1380 that arranged are in such way that they may deform perpendicularly to the direction of compression by the active action of the actuating pin 1204 pushing against the poppet head 1330. The deformation of the poppet 1302 may not affect its the axial alignment with the actuating pin 1204. A surface 1382 near the base of the poppet 1302 sits on top of the poppet seat 1320, and remains substantially stationary with respect to the valve body 1316 and the poppet seat 1320 which may be ultrasonically welded to the valve body 1316. When the poppet 1302 is compressed by the actuating pin 1204, fuel flows through an annular area created between the head 1330 of the poppet valve 1302 and the corresponding inner annular face of the cartridge valve body neck 1384 of the cartridge valve body 1316 which creates the seal when the cartridge valve 1300 is closed.

FIG. 64 shows positioning of a rubber seal ring 1306 and an absorbent material ring 1304. The rubber seal ring 1306 is placed in contact with the inner cylindrical face 1312 of the annular cavity 1340 of the valve body 1316. The absorbent material ring 1304 is placed in contact with the outer cylindrical face of the annular cavity 1340 of the valve body 1316. The annular space 1308 created between the absorbent material ring 1304 and the rubber seal ring 1306 is occupied by the entering nipples 1202 of the portable device valve 1200, which in turn creates a substantially sealed condition with the outer face 1310 of the rubber seal ring 1306. The absorbent ring 1304 may, for example, be manufactured using POREX®. The absorbent ring 1304 may catch stray drops of fuel that arise as the fuel cartridge valve 1300 disconnects from the portable device valve 1200. The absorbent ring 1304 acts as a sponge. Once the fuel cartridge is totally disconnected, those drops caught by the absorbent ring 1304 may gradually evaporate. The material for the rubber seal ring 1306 may optionally be chosen from one of these selected materials, with an approximate harness of 70 shore-A: EPDM, silicon rubber, and NEOPRENE®. Although the selected hardness for these seal materials develop a certain stiffness, the seal ring 213 component also squeezes around the valve body neck 1384 when the entering nipples 1202 contact the seal ring 1306, and a substantially sealed condition will be accomplished. Both absorbent ring 1304 and seal ring 1306 are inserted inside the annular cavity 1340 of the valve body 1316 by press fit insertion with a radial interference, of for example 0.1 mm to 0.2 mm, so they will not come loose before, during, or after use of the fuel cartridge.

A brief description of a sample connecting sequence between the cartridge valve 1300 and the device valve 1200 is as follows. The rubber seal ring 1306 on the cartridge valve body 1316 enters the nipple 1202 on the device valve body 1210. The rubber poppet 1302 and the device valve 1300 remain closed. Secondly, the seal between the cartridge valve body 1316 and the device nipple 1202 may be established. The flat faces 1350 of the cartridge valve body 214 and the device valve body 1210 are in contact but both valves are still closed. The flat face 1350 of the cartridge valve body 1316 pushes the device valve body 1210 back, thereby opening the portable device valve 1200. The actuating pin 1204, fixed to the device body 1210, touches the rubber poppet 1302 of the cartridge valve 1300 but has not opened it yet. Thereafter, both valves are open, fuel flows through the cartridge valve body 1300 around the rubber poppet 1302, around the actuating pin 1204, outward through the face flow channels, along the annular flow space, and outward into the device 1200. The disconnect sequence occurs in the reverse order of that as described above.

FIG. 68 shows a detail cross-section of the fuel cartridge valve body 1316. In this view, the annular cavity 1308 for the absorbent ring 1304 and the seal ring 1306 may be seen. A rectangular indent 1352 houses a poppet seat 1320, such as is shown in FIG. 64. After placing a poppet 1302 resting on poppet seat 1320, both components are inserted inside the hollow chamber 1354 of the fuel cartridge valve body 1316. After this operation, the poppet seat 1320 may be welded by an ultrasonic method to the valve body 1316. As shown in FIG. 68, internal ribs 1356 provide robustness to the valve body 1316. This concept maintains the wall thickness of a plastic component as constant. In this case, a coring procedure may be used to eliminate mass material from this particular area of the valve body 1316 by adding steel to the tool (mold). Round corners 1358 have been added to minimize stress concentrations points. Third, on the lower face 1364 of the annular flange 1362 of the valve body 1316, there is an “energy director” string 1366, which may be used when valve body 1316 is ultrasonically welded to the fuel cartridge housing 306 by using this face 1364 as a welding surface. Ultrasonic weld points are indicated by label 1366. The cross-section of the “energy director” corresponds to a square triangle with 90° vertex and an approximate height of 0.4 mm to 0.5 mm.

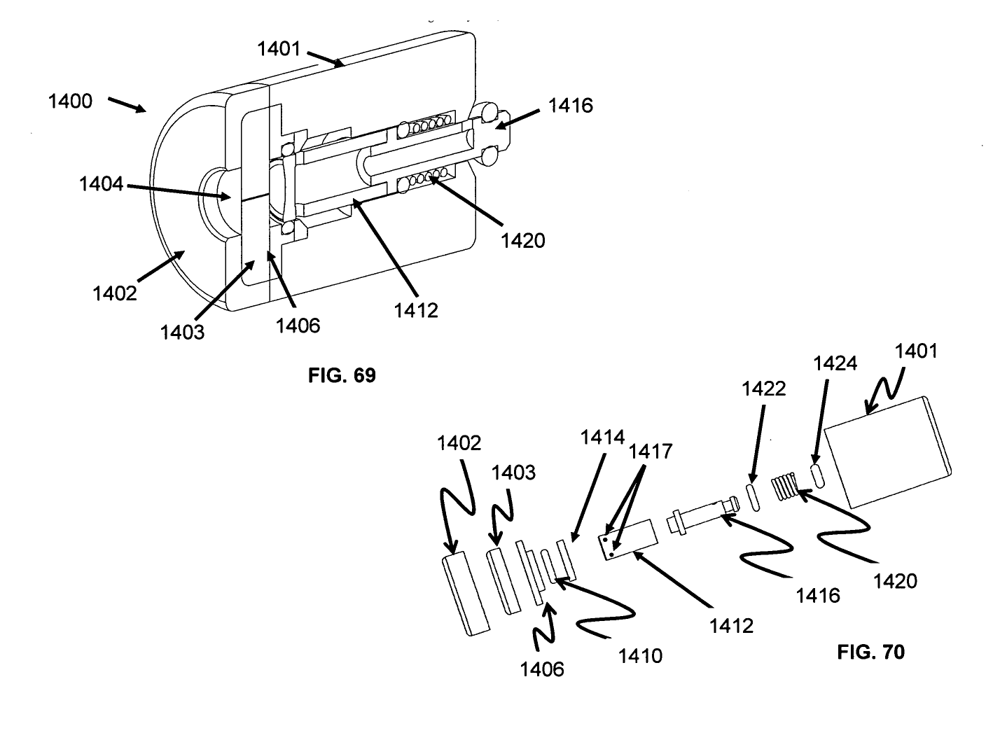

Another implementation of a fuel cartridge valve is illustrated in FIGS. 69-72. FIG. 69 shows a cross section of a fuel cartridge valve 1400. The cartridge valve housing 1401 is represented as a cylinder but may be any geometric shape. The cartridge valve housing 1401 may be fully integrated as part of the fuel cartridge body or may function as a standalone valve that is integrated into a fuel cartridge body.

FIG. 70 illustrates the individual components of the cartridge valve depicted in FIG. 69. In this implementation, a septum cover 1402 encapsulates the septum 1403 that has an inner face 1404 and an outer face 1405. The septum back cover 1406 may secure the septum 1403 from being displaced when the device valve is inserted. An internal sealing interface 1410 which may be a cannula O-ring 1410 creates a water tight seal between the body of the cartridge valve cannula 1412 and the valve body 1401 or other enclosing member. The O-ring cover 1414 holds the cannula O-ring 1410 in place. The cartridge valve cannula 1412 is closed at the end nearest the inner face 1404 of the septum and 1403 substantially open at the opposite end near a cartridge valve plunger 1416. The cartridge valve cannula 1412 includes one or more one cannula holes 1417 near the closed end. The cannula holes 1417 may be approximately perpendicular to the valve axis. In one example, the size of these cannula holes 1417 may range from approximately 0.1 to 10 mm. An open end of the cartridge valve plunger 1416 nearest the open end of the cartridge valve cannula 1412 connects the internal volume of the cartridge valve plunger 1416 to the internal volume of the cartridge valve cannula 1412. Near the opposite end of the cartridge valve plunger 1416, a plunger hole 1418 allows fuel to flow into the cartridge valve plunger 1416 and from there into the cartridge valve cannula a fuel reservoir that is connected via a flow path to the plunger hole 1418. When the cartridge valve 1400 is not coupled to a device valve 1500, a plunger spring 1420 biases the cartridge valve plunger 1416 against the cartridge valve cannula 1412 which in turns biases the cartridge valve cannula 1412 toward the inner face of the septum 1403. In this closed position, the internal sealing interface 1410 aligns with and seals the cannula holes 1417. A plunger O-ring 1422 may provide a seal between the exterior of the cartridge valve plunger 1416 and the interior of cartridge valve housing 1401.

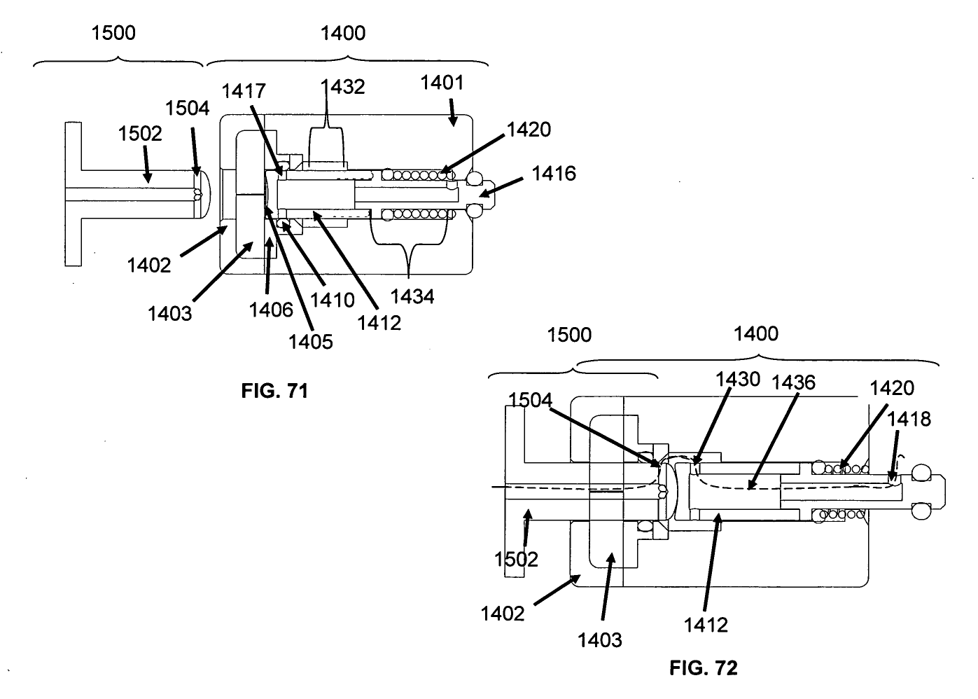

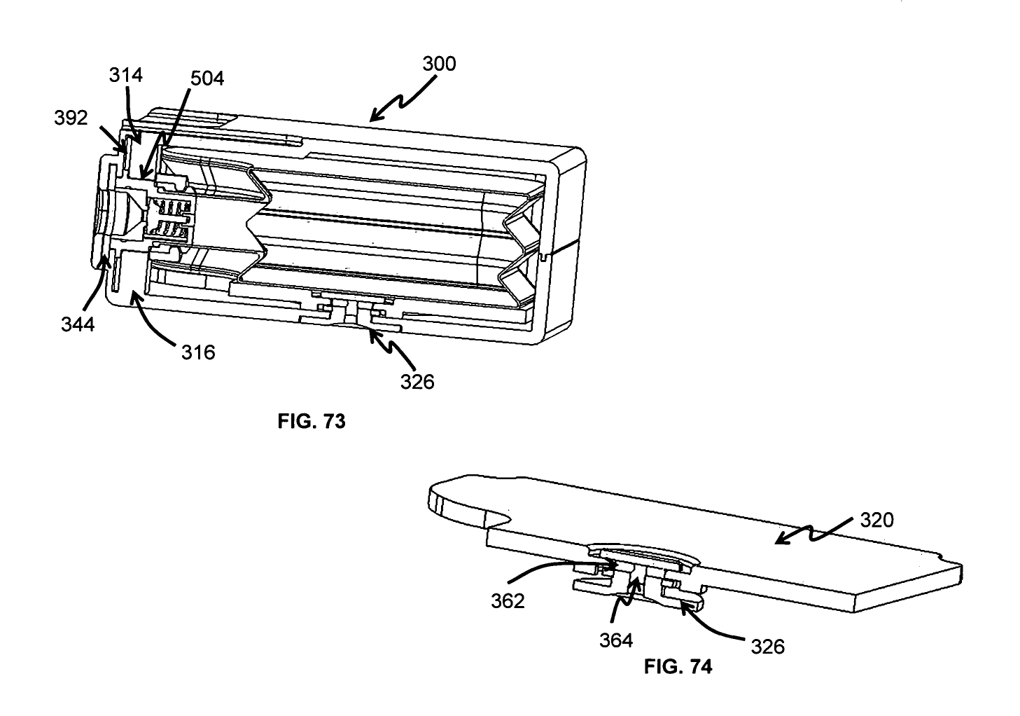

The function of the cartridge valve is depicted in FIG. 71 and FIG. 72. FIG. 71 shows the cartridge valve 1400 and a device valve cannula 1502 of a device valve 1500 prior to connection. Prior to actuation of the cartridge valve 1400, the internal sealing interface or cannula O-ring 1410 prevents any fluid flow from occurring by sealing the cannula holes 1417. The cartridge valve cannula 1412 slides between into the internal sealing interface under biasing from the plunger spring 1420 via the cartridge valve plunger 1416. The plunger spring 1420, cartridge valve plunger 1416, cartridge valve housing O-ring 1422, and cartridge valve housing body 1402 work to create a substantial seal preventing fluid from escaping prior to actuation of the coupled valves. The cartridge valve 1400 includes a fuel exchange chamber 1432 that encompasses at least part of the cartridge valve cannula 1412. The length of the fuel exchange chamber 1432 may optionally be in the range of approximately 0.1 to 20 mm.

When a coupling member 1502 of a device valve 1500 passes through the septum 1403, the coupling member exerts an opening force that moves the cartridge valve cannula 1412 away from the septum inner face 1405 and breaks the seal between the internal sealing interface 1410 and the cannula holes 1417. The coupling member 1502 includes at least one fuel port 1504 in the side of the coupling member 1502. The fuel port 1504 may be connected by an device valve internal flow path to a fuel consuming component or device. The coupling member may an approximately similar cross-sectional shape and area to the cartridge valve cannula 1412 so that as the coupling member 1502 enters the fuel exchange chamber 1532 a seal is formed between the coupling member and the internal sealing member 1410. The coupling member 1502 moves far enough into the cartridge valve body 1401 to connect the fuel port 1504 with the fuel exchange chamber 1532. A plunger stroke chamber 1434 is also depicted in FIG. 71. This chamber houses the plunger spring 1420 and allows for the cartridge valve plunger 1416 to move axially back and forth along the length of the plunger spring chamber 1434 in response to biasing form the plunger spring 1420 and biasing from the coupling member 1502 of the device valve 1500.

FIG. 72 depicts the cartridge valve 1400 when actuated. The device valve coupling member 1502 actuates the cartridge valve 1400 when the fuel cartridge 300 is inserted into a fuel consuming device 100. The coupling member 1502 exerts an opening force against the closed end of the cartridge valve cannula 1412 until the fuel cartridge 300 is fully seated in a docking station 200 or some other feature of the fuel consuming device 100 or until a mechanical stop is reached in either the device valve 1500 or the cartridge valve 1400. The mechanical stop may be adapted onto the body or housing 306 of a fuel cartridge 300 as well. When the coupling member 1502 is initially inserted, the septum 1403 creates an initial seal around the coupling member 1502 prior to the cartridge valve internal flow path being opened. As the coupling member 1502 is fully inserted into the cartridge valve 1400 it begins to depress on the cartridge valve cannula 1412, thus breaking the seal between the internal sealing interface 1410 and the cannula holes 1417. When fully inserted the coupling member 1502 and the cartridge valve cannula 1412 create a fluid path as shown by the dotted line 1436 in FIG. 72. Fuel flows into the cartridge plunger 1416 via the plunger hole 1418, from the cartridge plunger 1416 into the cartridge valve cannula 1412, out of the cartridge valve cannula 1412 into the fuel exchange chamber 1532, and into the fuel port 1504 on the coupling member 1502.

The plunger spring 1420 may be made from a type of stainless steel or other comparable material that is inert to the fuel used in this application. Two examples of stainless steel that may meet requirements are stainless steel 316 and stainless steel 304. The O-rings 1410, 1422 and 1424 and septum 1403 may be of a type of EDPM (ethylene propylene diene methylene), Buna N Nitrile, Natural Rubber, Silicone, and NEOPRENE® (Dupont), or other comparable materials.

In this variation, the septum 1403, septum back cover 1406, O-ring cover 1414, cartridge valve cannula 1412, cartridge valve plunger 1416 and cartridge valve housing 1401 may be made of polymers including but not limited to PEEK (Polyetherether Ketone), DELRIN AF BLEND ACETAL®, and/or metals including, but not limited to, stainless steel such as stainless steel 316 and/or 314 or the like. Manufacturing processes for the septum cover 1402, septum 1403, septum back cover 1406, O-ring cover 1416, cartridge valve cannula 1414, cartridge valve plunger 1420, and cartridge valve housing 1401 may include, but are not limited, to C-N-C machining and standard machining practices, injection molding, blow molding, compression molding and metal stamping. Joining components together such as the septum 1403 to the septum back cover 1406, the septum back cover 1410 to the cartridge valve housing 1401 and the cartridge valve cannula 1412 to the cartridge valve plunger 1416 may be performed via ultrasonic welding, rotational welding and/or by the use of adhesives.

The assembly of a fuel cartridge 300 as described herein may be accomplished in one example as follows. A sub-assembly of a cartridge valve 500 and fuel reservoir 310 is constructed. Then, assembly of the first sub-assembly and housings (top 314 and bottom 316) proceeds using an ultrasonic welding process. The design for a fuel cartridge 300 may comply with standards of design for manufacturing and design for assembly.

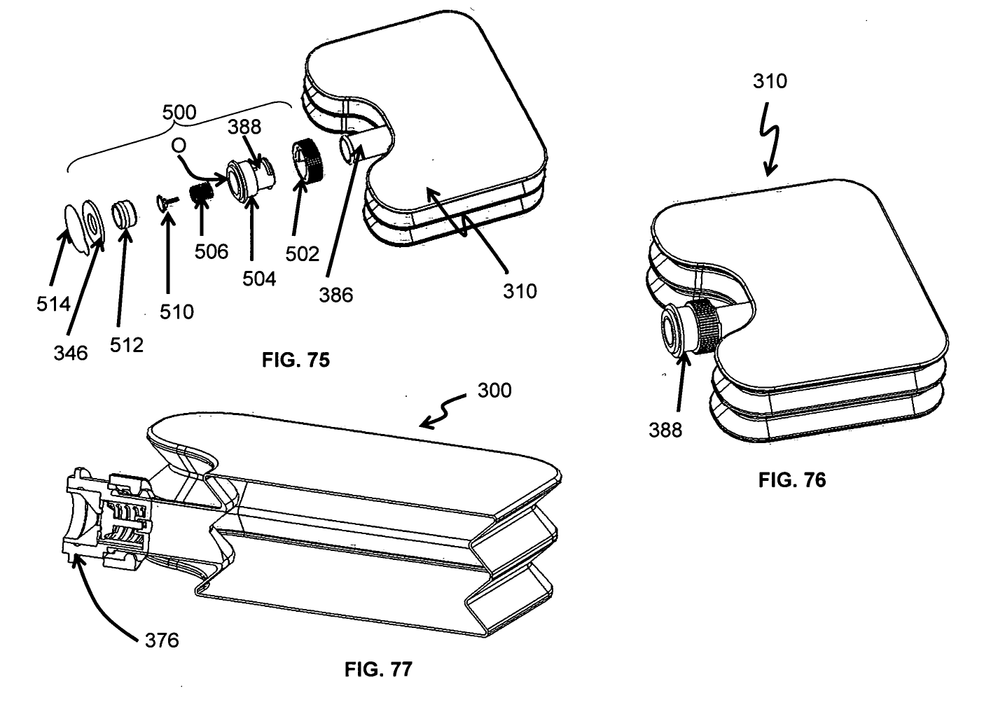

FIG. 75 shows an exploded view of components that may form the first sub-assembly (fuel cartridge valve 500 and fuel reservoir 310), disposed in the order they are assembled. An assembly process for such a fuel cartridge is described below. The first step may be inserting the poppet spring 506 into the valve body 504. The poppet spring 506 fits snugly in the cylindrical cavity of the valve body 604. The poppet 510 is inserted in the direction shown in the exploded view depicted in FIG. 75, i.e., introducing the stem of the poppet 510 first. The deformable ring 512 is press fitted into the valve body 504. Because of the interference between the two bodies, the insertion may not be as easy as that of the previous steps described above, but the force required is substantially low and consequently, it is an easy operation for the assembly operator. After the fuel cartridge valve 500 is assembled, the holder lock 601 is inserted into the fuel reservoir neck 386, so it remains loose around the neck in preparation for the next step. The fuel reservoir neck 386 is inserted into the valve body neck 388 by slightly pulling the fuel reservoir neck 386 to enter the valve body neck 388. The flexibility of the material of the fuel reservoir 310 allows this operation. The holder lock 502 is rotated around the fuel reservoir neck 386, so its internal locking arms 562, 563, 564, 565 do not interfere with the external locking arms 570, 571 of the valve body 504. Once the fuel reservoir neck 386 is inserted into the valve body neck 388, the holder lock 502 is rotated, for example approximately 90° clockwise, so the fuel reservoir neck 386 is trapped and safely secured. The friction between the rubber material of the fuel reservoir 310 and the holder lock 502 makes this operation reliable, so the holder lock 502 will not come loose. The sub-assembly including fuel cartridge valve 500 and fuel reservoir 310 is completed, as it is depicted in FIG. 76. For clarity purposes, FIG. 77 shows a cross-section of the complete sub-assembly of the fuel reservoir 310 and the cartridge valve 500.

Having completed the sub-assembly of the fuel reservoir 310 and cartridge valve 500, the housing is prepared for final assembly. FIG. 5 shows a complete exploded view of all the components of the fuel cartridge 300. The two pressure plate biasing elements (conical springs in this example) 322 are placed on top of the inner surface 332 of the bottom housing 316. There are two circular protrusions or annular bosses 330 on such face 332 to accommodate the two conical springs 322. Thereafter, the pressure plate 320 may be pressed down against the inner surface 332 until the thickness of the last coil spring does not allow any further movement of the pressure plate 320. The pressure plate 320 may be guided on its four corners by the corresponding guiding features 334 of the bottom housing 316. The two conical springs 322 may be compressed by performing this operation. The pressure plate may be held down against the inner surface 332 Then, from the opposite face, outer face 356, the locking element or ventilation plug 326 is inserted through the center hole 391 disposed at such effect. After inserting the ventilation plug 326 through the hole 391 in the bottom housing 316, and maintaining the pressure plate 320 down against the inner surface 332, a retaining ring 324 holds the holder lock. This retaining ring 324 may be of a standard stock size, and the material may be stainless steel 316 or 304 or other comparable materials with consideration given to inertness to reactions with the fuel, such as for example methanol. The ventilation plug 326 is then rotated 90° (clockwise or counterclockwise), so its head will be locked and the pressure plate 320 will now be held by the wing or wings 363 of the ventilation plug 326. The assembly operator releases the force over the pressure plate 320 to keep it down against the bottom housing inner surface 332. The result of this operation is that the pressure plate 320 is now held down against the housing inner surface 332.

At this point, the sub-assembly of the fuel reservoir 310 and the valve body 504 may be placed on top of the pressure plate 320, which is being held down by the ventilation plug 326. Because of the symmetry of the mentioned sub-assembly, there is no face of the fuel reservoir 310 to contact the pressure plate 320. To ensure the correct assembly between the sub-assembly and the bottom housing 312, the circular flange 576 of the valve body 504 is inserted inside its corresponding annular cavity 392 in the top housing 314, as shown in FIG. 77. The absorbent disc 344 is inserted on its corresponding cylindrical cavity 344 on the bottom housing 312, as shown in detail in FIG. 76. After this operation, the top housing 314 is placed on top of the bottom housing 312, with both parts now aligned, as shown in FIG. 76, so the ultrasonic welding process can now be performed. The complete assembly of the fuel cartridge 300 has been accomplished after this operation.

The next step will be to fill the fuel cartridge fuel reservoir 310 inside the fuel cartridge 300 with fuel. Once the fuel reservoir 310 is filled with the desired volume of fuel, the adhesive safety vinyl cover 374 is attached on top of the outer surface of the cartridge valve 500, as shown in FIG. 77. The volume of fuel used in one variation may be approximately 50 mL. The last operation of this manufacturing process is releasing the pressure plate 320 by turning the ventilation plug 326 approximately 90°, either clockwise or counterclockwise. The suggested method to turn the ventilation plug 326 may be by using a coin and that is inserted in the corresponding cavity 390 in the ventilation plug 326, as shown in FIG. 74, and turning it approximately 90° in either direction. Having performed this action, the ventilation plug 326 remains in place, so it does not fall off the fuel cartridge 300 because the retaining ring 324 is holding it, and the pressure plate 320 starts a positive pressure action against the fuel reservoir 310, inside the cartridge 300. Finally, the fuel cartridge 300 is ready to be stored within its designed packaging box or other storage or retail container.

The fuel cartridge 300 described herein may provide one or more benefits. Many of the O-rings and springs used are components that can be purchased from standard stock parts. Plastic parts, except for the flexible fuel container or fuel reservoir 310, are parts made by a regular plastic injection molding process. The fuel reservoir 310 may be made by a regular blow molding process. The usage of regular injection and blow molding processes lowers the manufacturing cost of the fuel cartridge and also permits the use of complex design features which may be more difficult to fabricate using other technologies. The materials used for all the parts in contact with the fuel are inert materials to the fuel contained in the cartridge, such as natural rubber, stainless steel, polycarbonate, LDPE, EPDM, or other comparable materials. The alignment features on the outer surface of the top housing 314 provides the proper alignment of the fuel cartridge 300 with the docking station 200 of the portable device 100. The fuel reservoir 310 design allows a volumetric efficient flexible container within the fuel cartridge 300, which will deliver the desired volume of fuel. In one implementation for use with a laptop computer, a fuel cartridge 300 may deliver approximately 50 mL of fuel at a flow rate of approximately 10 mL per hour. The fuel may be delivered from the inner fuel reservoir 310 to the fuel consuming device 100, through a device valve 400, with zero leakage throughout the complete fuel flow path. In addition, the fuel may be delivered from the inner fuel reservoir 310 to the fuel consuming device 100 assuming any orientation of the cartridge 300 and the fuel consuming device 100. The fuel cartridge 300 does not require an internal or an external pump to deliver the fuel, because internal positive pressure is provided by the pressure plate 320 as biased by the pressure plate biasing element or elements 322. The pressure drop between the cartridge and the ambient is negligible, since the fuel cartridge 300 may be vented, for example through ventilation plug 326.

The variations described hereinabove with reference to the accompanying drawings may not depict all the components of a complete implementation of the fuel delivery system of the subject matter described herein, nor are all of the varying component layout described. Different size, materials, shape, form, function and manner of operation, assembly and use of the various elements of the valves and cartridges described herein are possible without departing from the scope and spirit of the subject matter described herein. Use of the term “axis” in the description and claims does not limit the scope of the disclosed subject matter to shapes with full rotational symmetry. Rather, “axis” may optionally refer to a cross sectional center of gravity for a volumetric shape.

What is claimed is:

1. An apparatus comprising:
an internal flow path having a first flow end and a second flow end;
a fuel reservoir connected to the first flow end;
a deformable ring comprising a substantially cylindrical outer surface, a first end and a second end, a circumferential ridge disposed between the first end and the second end encircling the outer surface, and an annular opening that leads from a first opening on the first end to a second opening on the second end, the annular opening comprising an approximately cylindrical region near the first end and a conical region that tapers from the cylindrical region to the second end, the second opening being of smaller diameter than the first hole;
a movable internal sealing member disposed within the internal flow path proximate to the second opening, the internal sealing member being biased against the second opening by a biasing force to form a liquid-tight internal seal that closes the second opening to block the internal flow path, the internal sealing member breaking the internal seal when a device valve of a separate apparatus contacts and forms an external seal with the conical region and then extends an actuating member through the annular opening to exert an opening force directed substantially opposite to the direction of the biasing force on the internal sealing member.

2. An apparatus as in claim 1, wherein the deformable ring comprises a raised circular ridge around the second opening and the internal sealing member comprises a convex sealing head that forms the internal seal when biased against the raised circular ridge.

3. An apparatus as in claim 1, further comprising:
a biasing support disposed within the internal flow path; and
an outwardly biased element providing the internal biasing force and comprising a first spring end in contact with the biasing support and a second spring end in contact with the internal sealing member.

4. An apparatus as in claim 1, wherein the separate apparatus comprises a fuel consuming device or a fuel cell.

5. An apparatus as in claim 1, wherein the fuel reservoir comprises a bladder, or a container with two opposing, substantially similarly sized, and substantially parallel sides that are connected by a deformable side wall.

6. An apparatus as in claim 1, wherein the deformable ring comprises an absorbent material that absorbs fuel released during a coupling or a decoupling of the external sealing interface with the coupling member of the device valve.

7. An apparatus as in claim 1, wherein the internal sealing member comprises:
a poppet pin comprising a poppet head and a poppet stem, the poppet head having a sealing face comprising a poppet sealing feature that mates with an internal sealing interface feature of the internal sealing interface to create the internal seal, the poppet stem extending from the poppet head opposite the sealing face; and
a poppet spring disposed around the poppet stem, the poppet spring providing the internal biasing force.

8. An apparatus as in claim 7, further comprising a valve body with an open valve body end, a closed valve body end that comprises a fuel port hole, and a seating surface disposed within the valve body between the open end and the closed end, the valve body enclosing the internal sealing member and the deformable ring, the second end of the deformable ring seating on the seating surface, a first end of the poppet spring contacting the closed valve body end and a second end of the poppet spring contacting the poppet head opposite the poppet face.

9. An apparatus as in claim 8, wherein the poppet stem passes through the fuel port when the opening force is exerted on the internal sealing member and the poppet stem comprises a channel that allows fuel to flow past the poppet stem between the fuel reservoir and the external sealing interface.

10. An apparatus as in claim 8, wherein the valve body further comprises a fuel conducting groove along an internal surface, the fuel conducting groove extending from near the closed end to the seating surface to conduct fuel around the poppet head.

11. An apparatus as in claim 1, further comprising a substantially planar pressure plate that applies a pressure against a side of the fuel reservoir, the pressure being substantially uniform with distance across the side of the fuel reservoir.

12. An apparatus as in claim 1, further comprising:
a fuel cartridge housing to substantially enclose the fuel reservoir;
a substantially planar pressure plate disposed proximately to a side of the fuel reservoir; and
a pressure plate biasing element disposed between an internal surface of the fuel cartridge housing and the pressure plate, the pressure plate biasing element providing a pressure plate biasing force that biases the pressure plate against the side of the fuel reservoir to provide a pressure that is substantially uniform with distance over the side of the fuel reservoir.

13. An apparatus as in claim 12, further comprising a ventilation plug disposed in ventilation port that passes through the housing, the ventilation plug allowing air pressure within the fuel cartridge housing to equalize with ambient pressure and comprising:
a first plug section, a second plug section, and a third plug section, all disposed along a common axis, the first plug section comprising an outer face disposed opposite to the second plug section and the third plug section, the second plug section having a smaller cross-sectional area than the first plug section, the third plug section comprising at least one wing that extends wider than the second plug section;
a blind hole aligned along the common axis and extending from the outer face and at least partially through the second plug section;
a through hole passing through the second plug section substantially perpendicularly to the common axis, the through hole intersecting the blind hole; and
a porous material filling the blind hole, the porous material being permeable to gases but substantially impermeable to liquids.

14. A method comprising:
initiating a coupling of a fuel cartridge valve with a device valve of a device, the fuel cartridge valve comprising an internal flow path having a first flow end and a second flow end; a fuel reservoir connected to the first flow end; a deformable ring comprising a substantially cylindrical outer surface, a first end and a second end, a circumferential ridge disposed between the first end and the second end encircling the outer surface, and an annular opening that leads from a first opening on the first end to a second opening on the second end, the annular opening comprising an approximately cylindrical region near the first end and a conical region that tapers from the cylindrical region to the second end, the second opening being of smaller diameter than the first hole; a movable internal sealing member disposed within the internal flow path proximate to the second opening, the internal sealing member being biased against the second opening by a biasing force to form a liquid-tight internal seal that closes the second opening to block the internal flow path; and the device valve comprising a coupling member configured to form a liquid-tight external seal with the conical region and provide a liquid-tight external flow path connecting the device valve to the fuel reservoir via the internal flow path, and an actuating member;
extending the actuating member through the annular opening to exert an opening force directed substantially opposite to the direction of the biasing force on the internal sealing member to break the break the internal seal; and
causing fuel to flow between the fuel cartridge housing and the device.

15. A method as in claim 10, wherein the device is a fuel consuming device or a fuel cell.

16. A method as in claim 10, wherein the fuel cartridge valve further comprises:
a biasing support disposed within the internal flow path; and
an outwardly biased element providing the internal biasing force and comprising a first spring end in contact with the biasing support and a second spring end in contact with the internal sealing member.

17. A valve element comprising:
a ring formed of a deformable material and comprising a substantially cylindrical outer surface, a first end and a second end, and an annular opening that leads from a first opening on the first end to a second opening on the second end, the annular opening comprising an approximately cylindrical region near the first end and a conical region that tapers from the cylindrical region to the second end, the second opening being of smaller diameter than the first hole.

18. A valve element as in claim 17, further comprising a raised circular ridge on the second end that encircles the second hole.

19. A valve element as in claim 17, further comprising a circumferential ridge disposed between the first end and the second end and that encompasses the outer surface, the circumferential ridge securing the valve element in place when the valve element is assembled in a compatible valve body.

20. A method as in claim 17, wherein the deformable ring comprises an absorbent material that absorbs fuel released during a coupling or a decoupling of the conical region with the coupling member of the device valve.
